(19) United States
(12) Patent Application Publication
(10) Pub. No.: US 2012/0135803 A1
(43) Pub. Date: May 31, 2012

(54) GAME DEVICE UTILIZING STEREOSCOPIC DISPLAY, METHOD OF PROVIDING GAME, RECORDING MEDIUM STORING GAME PROGRAM, AND GAME SYSTEM

(75) Inventors: Toyokazu NONAKA, Kyoto-shi (JP); Tomoyoshi Yamane, Kyoto-shi (JP); Norihito Ito, Kyoto-shi (JP)

(73) Assignee: NINTENDO CO., LTD., Kyoto (JP)

(21) Appl. No.: 13/267,233

(22) Filed: Oct. 6, 2011

(30) Foreign Application Priority Data
Nov. 30, 2010 (JP) 2010-266940

(51) Int. Cl. A63F 13/00

(52) U.S. Cl. 463/31

(57) ABSTRACT

An exemplary embodiment provides game device that stereoscopically displays a game image by utilizing parallax. The game device includes a display portion capable of providing stereoscopic display, an image pick-up portion, an object setting unit for setting a position of display of an object with respect to the display portion and arranging the object at a corresponding position in a virtual space, a display control unit for setting parallax based on the position of display of the object in a direction of depth of the display portion for causing the display portion to stereoscopically display the object, an indicated position calculation unit for calculating a relative position of an indicator with respect to the image pick-up portion based on an image of the indicator, and a game processing unit for performing game processing based on relation between the position of display of the object and the calculated relative position.

This nonprovisional application is based on Japanese Patent Application No. 2010-266940 filed with the Japan Patent Office on Nov. 30, 2010, the entire contents of which are hereby incorporated by reference.

### FIELD

The invention generally relates to a game device stereoscopically displaying a game image by utilizing parallax, a method of providing a game, a recording medium storing a game program, and a game system.

### BACKGROUND AND SUMMARY

An interface allowing a user to operate a touch panel to move an object displayed in a virtual space has conventionally been provided. For example, such a configuration that a coordinate in a virtual three-dimensional space is calculated based on an input from a device for inputting a two-dimensional coordinate on a display screen to thereby generate an instruction to move the object in the virtual space has been known.

According to the configuration described above, since the user performs an operation to touch the touch panel on a plane, the user is less likely to feel that the user touches an object present in an actual space even if he/she moves the object in the virtual space.

An exemplary embodiment provides a novel game device having a user feel as if he/she directly touched an object, a method of providing a game, a game program, and a game system.

An exemplary embodiment provides a game device for providing stereoscopic display of a game image by utilizing parallax. The game device includes a display portion capable of providing stereoscopic display, an image pick-up portion, an object setting unit for setting a position of display of an object with respect to the display portion and arranging the object at a corresponding position in a virtual space, a display control unit for setting parallax based on the position of display of the object in a direction of depth of the display portion for causing the display portion to stereoscopically display the object, an indicated position calculation unit for calculating a relative position of an indicator with respect to the image pick-up portion based on an image of the indicator of which image is picked up by the image pick-up portion, and a game processing unit for performing game processing based on relation between the position of display of the object and the calculated relative position.

According to the exemplary embodiment, the user feels as if he/she directly touched a stereoscopically displayed object. Namely, according to the user interface provided by the exemplary embodiment, a user input provided onto the touch panel on the plane is an input in a stereoscopic, three-dimensional coordinate, rather than an input in a planar, two-dimensional coordinate. In addition, since the input is detected in association with the stereoscopically displayed object, the user feels with a sense of reality that he/she provides an intuitive input onto the object.

As a result of a direct input operation provided by such a user interface, the user can perform a desired operation with motion close to real life and can also obtain look and feel with a sense of reality.

In an exemplary embodiment, the game device further includes a first housing provided with the display portion on one surface, and the image pick-up portion is provided in a surface of the first housing common to a surface where the display portion is provided.

According to the exemplary embodiment, for an object that looks like popping up from the display portion toward the user, such a user interface as being directly touched and operated by the user can be realized.

In an exemplary embodiment, the game device further includes a first housing provided with the display portion on one surface, and the image pick-up portion is provided in a surface of the first housing opposite to the display portion.

According to the exemplary embodiment, for an object that looks like recessed from the display portion toward a side opposite to the user, such a user interface as being directly touched and operated by the user can be realized.

In an exemplary embodiment, the display control unit causes the display portion to display an image picked up by the image pick-up portion together with an image of the object.

According to the exemplary embodiment, such a user interface as augmented reality can be provided.

In an exemplary embodiment, the indicator is a stylus having a marker at a tip end, and the indicated position calculation unit calculates a position of the stylus in the direction of depth of the display portion based on a size of an image representing the marker within an image picked up by the image pick-up portion.

According to the exemplary embodiment, by picking up an image of a range including a marker representing an indicator with the use of a general image pick-up portion, a position where the marker is present in the direction of depth of the display portion can be calculated. Namely, since a position of the marker in the direction of depth can be calculated without preparing a special image pick-up portion, cost can be suppressed. By adopting such a feature, the user can provide a desired instruction by performing an operation using a stylus having a marker.

In an exemplary embodiment, the stylus includes a vibration generation portion for generating vibration, and the game processing unit performs game processing based on the calculated position of the stylus and causes the vibration generation portion to generate vibration as the game processing proceeds.

According to the exemplary embodiment, the user can feel as if he/she actually touched an object, and when he/she performs some kind of operation, he/she also can feel vibration as response (feedback) thereto. Thus, the user can visually obtain feeling as if he/she directly touched the object and can also physically feel as such.

In an exemplary embodiment, the game device further includes a second housing coupled to the first housing to be foldable and a touch panel provided in the second housing, and the game processing unit further performs game processing based on an input on the touch panel.

According to the exemplary embodiment, the user can not only perform an operation by moving the indicator but also proceed with a game by using a common touch panel. Therefore, the user can enjoy feeling of directly touching an object and indicate smooth game proceeding.

In an exemplary embodiment, the game device further includes a lens removably provided in the image pick-up portion, for guiding an image all around the image pick-up portion to the image pick-up portion.

In an exemplary embodiment, the game device further includes a wide-angle lens removably provided in the image pick-up portion.

In an exemplary embodiment, the game device further includes a reflection optical system removably provided in the image pick-up portion, for variably setting a range of image pick-up by the image pick-up portion.

According to the exemplary embodiment(s), even though an image pick-up portion attached to the game device does not necessarily cover the entire range in which the user moves (a range where an indicator can be present) as a field of view, the image pick-up portion can be used to enjoy a game according to the exemplary embodiment(s). Therefore, as compared with a case where an image pick-up portion is newly added, necessary cost can be suppressed.

An exemplary embodiment implements a method of providing a game including stereoscopic display of a game image by utilizing parallax, in a game device having a display portion capable of providing stereoscopic display. The method of providing a game includes an object setting step of setting a position of display of an object with respect to the display portion and arranging the object at a corresponding position in a virtual space, a display control step of setting parallax based on the position of display of the object in a direction of depth of the display portion for causing the display portion to stereoscopically display the object, an indicated position calculation step of calculating a relative position of an indicator with respect to an image pick-up portion based on an image of the indicator of which image is picked up by the image pick-up portion, and a game processing step of performing game processing based on relation between the position of display of the object and the calculated relative position.

In an exemplary embodiment, the display control step includes the step of displaying an image picked up by the image pick-up portion with respect to the display portion together with an image of the object.

In an exemplary embodiment, the indicator is a stylus having a marker at a tip end, and the indicated position calculation step includes the step of calculating a position of the stylus in the direction of depth of the display portion based on a size of an image representing the marker within an image picked up by the image pick-up portion.

An exemplary embodiment provides a non-transitory storage medium encoded with a computer readable game program and executable by a computer of a game device including a display portion capable of providing stereoscopic display. The computer readable game program includes object setting instructions for setting a position of display of an object with respect to the display portion and arranging the object at a corresponding position in a virtual space, display control instructions for setting parallax based on the position of display of the object in a direction of depth of the display portion for causing the display portion to stereoscopically display the object, indicated position calculation instructions for calculating a relative position of an indicator with respect to an image pick-up portion based on an image of the indicator of which image is picked up by the image pick-up portion, and game processing instructions for performing game processing based on relation between the position of display of the object and the calculated relative position.

An exemplary embodiment provides a game system including an image pick-up portion and a game device for stereoscopically displaying a game image by utilizing parallax. The game device includes a display portion capable of providing stereoscopic display, an object setting unit for setting a position of display of an object with respect to the display portion and arranging the object at a corresponding position in a virtual space, a display control unit for setting parallax based on the position of display of the object in a direction of depth of the display portion for causing the display portion to stereoscopically display the object, an indicated position calculation unit for calculating a relative position of an indicator with respect to the image pick-up portion based on an image of the indicator of which image is picked up by the image pick-up portion, and a game processing unit for performing game processing based on relation between the position of display of the object and the calculated relative position.

According to the exemplary embodiment, even a game device not having an image pick-up portion in itself can realize game processing according to the exemplary embodiment by using an image picked up by an image pick-up portion provided in another entity.

The foregoing and other objects, features, aspects and advantages of the present embodiment(s) will become more apparent from the following detailed description of the present embodiment(s) when taken in conjunction with the accompanying drawings.

### BRIEF DESCRIPTION OF THE DRAWINGS

FIG. 1 shows an exemplary illustrative non-limiting drawing of an exemplary non-limiting user interface provided by a game device according to an exemplary embodiment.

FIG. 2 shows an exemplary non-limiting front view of the game device (in an opened state) according to the exemplary embodiment.

FIGS. 3A to 3D show exemplary non-limiting projection views with an upper surface side of the game device shown in FIG. 2 being the center.

FIGS. 4A and 4B show exemplary non-limiting projection views with a bottom surface side of the game device shown in FIG. 2 being the center.

FIG. 5 shows an exemplary non-limiting block diagram showing an electrical configuration of the game device according to the exemplary embodiment.

FIG. 6 shows an exemplary non-limiting block diagram showing an electrical configuration for implementing display control in the game device according to the exemplary embodiment.

FIG. 7 shows an exemplary non-limiting schematic cross-sectional view of an upper LCD shown in FIG. 6.

FIGS. 8A and 8B show exemplary non-limiting diagrams each for illustrating one example of a method of generating a pair of images used for stereoscopic display in the game device according to the exemplary embodiment.

FIGS. 9A and 9B show exemplary non-limiting diagrams each for illustrating a method of realizing stereoscopic display using the image generated with the method shown in FIGS. 8A and 8B.

FIG. 10 shows an exemplary non-limiting stylus used in the game device according to the exemplary embodiment.

FIG. 11 shows an exemplary non-limiting diagram illustrating principles in position detection in the game device according to the exemplary embodiment.

FIGS. 12 and 13 show exemplary non-limiting diagrams each illustrating processing for calculating a marker position in the game device according to the exemplary embodiment.

FIG. 14 shows an exemplary non-limiting diagram illustrating a configuration example including an omnidirectional camera in the game device according to the exemplary embodiment.

FIGS. 15A to 15C show exemplary non-limiting diagrams each illustrating contents in image processing on an image obtained by the omnidirectional camera shown in FIG. 14.

FIG. 16 shows an exemplary non-limiting configuration example including a wide-angle lens in the game device according to the exemplary embodiment.

FIG. 17 shows an exemplary non-limiting configuration example including a reflection optical system in the game device according to the exemplary embodiment.

FIG. 18 shows an exemplary non-limiting operation in a case where an outer camera is used in the game device according to the exemplary embodiment.

FIG. 19 shows an exemplary non-limiting screen example displayed on the upper LCD in the configuration shown in FIG. 18.

FIG. 20 shows another exemplary non-limiting operation in a case where the outer camera is used in the game device according to the exemplary embodiment.

FIG. 21 shows an exemplary non-limiting functional block diagram of the game device according to the exemplary embodiment.

FIG. 22 shows an exemplary non-limiting flowchart involved with a processing procedure performed in the game device according to the exemplary embodiment.

FIG. 23 shows an exemplary non-limiting external view of a stylus according to an exemplary embodiment.

FIG. 24 shows an exemplary non-limiting functional block diagram of the stylus according to the exemplary embodiment.

FIGS. 25 and 26 show exemplary non-limiting examples of a physical affection game provided by the game device according to the exemplary embodiment.

FIG. 27 shows an exemplary non-limiting example of a soap bubble carrying game provided by the game device according to the exemplary embodiment.

FIG. 28 shows an exemplary non-limiting example of a sketch game provided by the game device according to the exemplary embodiment.

FIGS. 29 and 30 show exemplary non-limiting examples of an iron ball carrying game provided by the game device according to the exemplary embodiment.

### DETAILED DESCRIPTION OF NON-LIMITING EXAMPLE EMBODIMENTS

Some embodiments will be described in detail with reference to the drawings. It is noted that the same or corresponding elements in the drawings have the same reference characters allotted and description thereof will not be repeated.

A portable game device 1 representing a computer will be described hereinafter as an information processing apparatus according to an exemplary embodiment. Game device 1 has at least one display portion capable of providing stereoscopic display and a game image can stereoscopically be displayed on this display portion by utilizing parallax, as will be described later.

The game device is not limited to an implementation as portable game device 1, and it may also be implemented as a stationary game device, a personal computer, a portable telephone, a portable terminal, or the like. In addition, as will be described later, an implementation as an information processing system including a recording medium storing a game program and a processing apparatus main body to which the recording medium can be attached may be possible as another exemplary embodiment.

### A. Definition

(1) In the present specification, “stereoscopic display”, “three-dimensional display” and “3D display” mean that an image is expressed such that the user can visually recognize at least a partial object included in the image stereoscopically. In order to have the user visually recognize the object stereoscopically, typically, physiological functions of eyes and brain of a human are utilized. Such stereoscopic display is realized by using images displayed such that an object is stereoscopically visually recognized by the user (typically, a stereo image having parallax).

(2) In the present specification, “planar display”, “two-dimensional display” and “2D display” are terms as opposed to “stereoscopic display” and the like described above, and they mean that an image is expressed such that the user cannot visually recognize an object included in the image stereoscopically.

### B. Overview

Game device 1 can stereoscopically display a game image by utilizing parallax. Namely, game device 1 provides a game including stereoscopic display of a game image by utilizing parallax.

In particular, game device 1 provides a user interface having a user feel as if he/she directly touched and operated an object stereoscopically displayed at least as a part of a game image. Namely, the user can feel that he/she moves an object displayed with respect to the display portion in response to his/her some kind of actual operation at a position where an object is viewed, on the object that looks like present at a certain position in a direction of depth of the display portion (although it is not actually present).

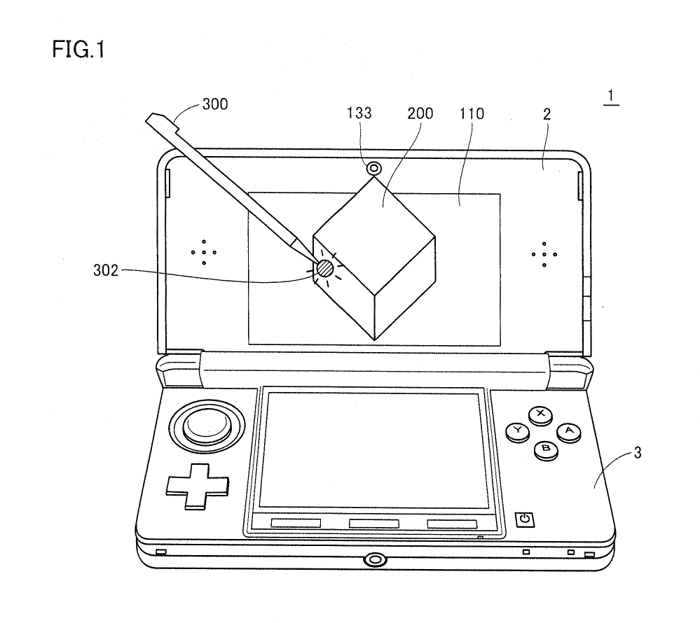

Referring to FIG. 1, game device 1 is constituted of an upper housing 2 and a lower housing 3 structured to be foldable, and an upper LCD 110 capable of providing stereoscopic display is attached to upper housing 2. This upper LCD 110 typically displays an image of an object 200 provided with prescribed parallax. Thus, the user can visually recognize presence of object 200 at a position in accordance with an amount of parallax in the direction of depth of upper LCD 110.

In addition, an image pick-up portion (typically, an inner camera 133) is attached to upper housing 2, and a user's operation is detected based on an image obtained by image pick-up by this image pick-up portion. Then, based on this detected user's operation and a position of object 200 visually recognized by the user, determination processing is performed and game processing proceeds in accordance with results of determination in this determination processing. More specifically, a stylus 300 or the like, to which a marker 302 for position detection representing an indicator is attached, is used for a user's operation, and a position of marker 302 is calculated based on an image of marker 302 obtained by the image pick-up portion.

Thus, in game device 1, the user can directly touch and operate an object visually recognized by the user stereoscopically with stylus 300 or the like, so that the user can be given such strange feeling that he/she can touch an object that is not actually present.

A configuration or the like for providing such a user interface will be described hereinafter in detail.

### C. Overall Configuration of Game Device

Initially, an overall configuration of game device 1 will be described.

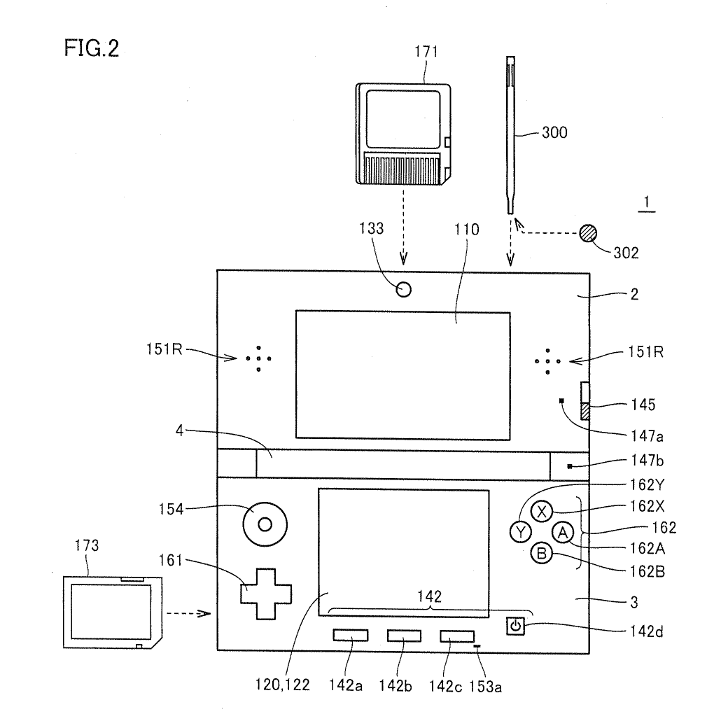

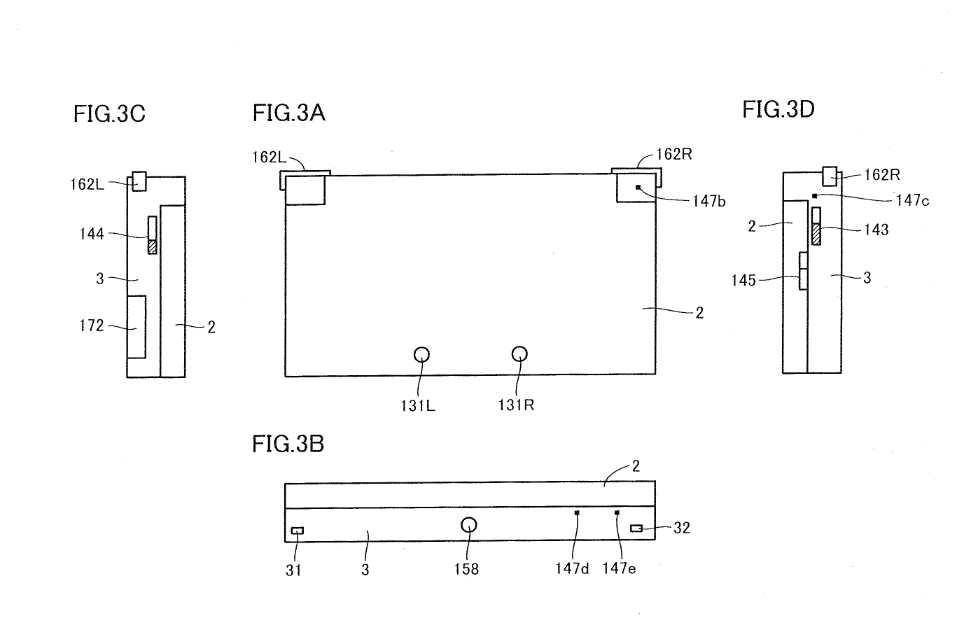

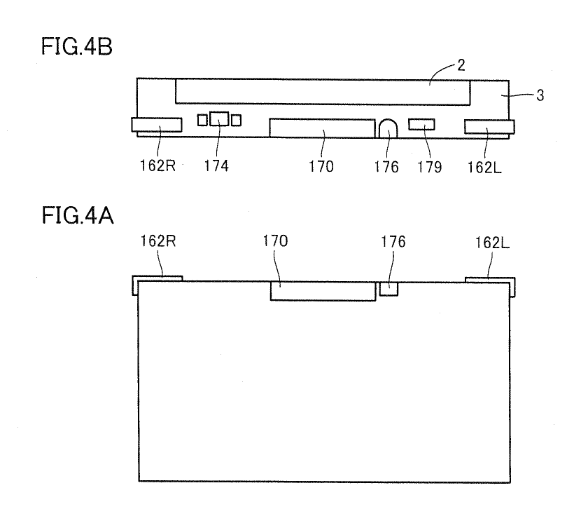

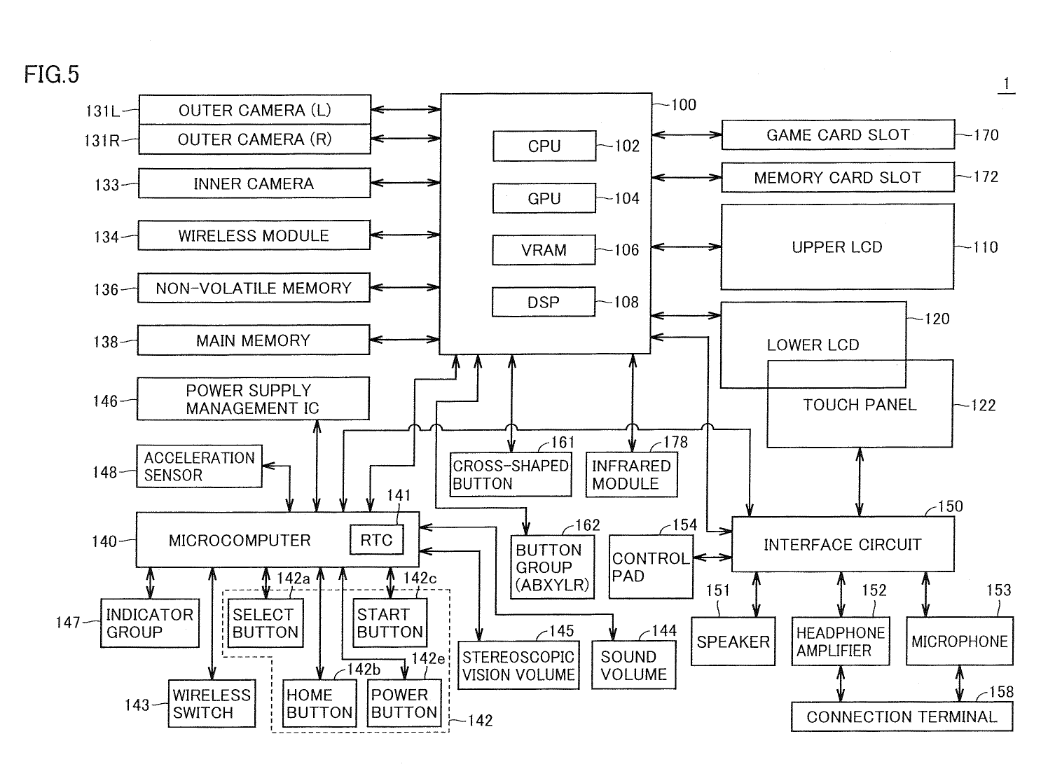

FIG. 2 shows a front view of game device 1 (in an opened state). FIG. 3A shows a top view of game device 1 (in a closed state), FIG. 3B shows a front view of game device 1, FIG. 3C shows a left side view of game device 1, and FIG. 3D shows a right side view of game device 1. FIG. 4A shows a bottom view of game device 1 and FIG. 4B shows a rear view of game device 1. In the present specification, for the sake of convenience, with arrangement of game device 1 as shown in FIG. 2 being the reference, the terms “top”, “front”, “left side”, “right side”, “bottom”, and “rear” are used, however, these terms are formally used and they do not intend to restrict a manner of use of game device 1 by the user.

Portable game device 1 is configured to be foldable. Appearance of game device 1 in an opened state is as shown in FIG. 2, and appearance thereof in a closed state is as shown in FIG. 3A. Game device 1 preferably has such a size that the user can hold game device 1 with both hands or one hand even in the opened state.

Game device 1 has upper housing 2 and lower housing 3. Upper housing 2 and lower housing 3 are coupled to be foldable (allow opening and closing). In the example shown in FIG. 2, upper housing 2 and lower housing 3 are each formed like a rectangular plate, and they are coupled to each other to be pivotable around a long side portion thereof by means of a hinge 4. Game device 1 is maintained in the opened state when used by the user and it is maintained in the closed state when not used.

In addition, in game device 1, an angle between upper housing 2 and lower housing 3 can also be maintained at any angle between a position in the closed state and a position in the opened state (approximately 0° to approximately 180°). In other words, upper housing 2 can rest at any angle with respect to lower housing 3. For resting of the housings, friction force or the like produced in a coupling portion between upper housing 2 and lower housing 3 is used. In addition to or instead of friction force, a latch mechanism may be adopted in the coupling portion between upper housing 2 and lower housing 3.

Upper LCD (Liquid Crystal Display) 110 is provided in upper housing 2 as the display portion (display means) capable of providing stereoscopic display. Upper LCD 110 has a rectangular display region and it is arranged such that a direction in which its long side extends coincides with a direction in which a long side of upper housing 2 extends. Such a configuration that upper LCD 110 greater in screen size than a lower LCD 120 is adopted in game device 1 so that the user can further enjoy stereoscopic display is shown. It is noted, however, that the screen size does not necessarily have to be different as such, and a screen size can be designed as appropriate, depending on usage of an application, a size of game device 1, or the like. A detailed configuration of upper LCD 110 will be described later.

An image pick-up device (image pick-up means) for picking up an image of some subject is provided in upper housing 2. More specifically, a pair of outer cameras 131L and 131R (see FIG. 3A) and inner camera 133 (see FIG. 2) are provided in upper housing 2. Here, inner camera 133 is arranged above upper LCD 110, while the pair of outer cameras 131L and 131R is arranged in a surface opposite to an inner main surface where inner camera 133 is arranged, that is, in an outer main surface of upper housing 2 (corresponding to a surface on the outside when game device 1 is in the closed state).

Based on such positional relation, the pair of outer cameras 131L and 131R can pick up an image of a subject present in a direction in which the outer main surface of upper housing 2 faces, while inner camera 133 can pick up an image of a subject present in a direction opposite to the direction of image pick-up by outer cameras 131L and 131R, that is, in a direction in which the inner main surface of upper housing 2 faces.

The pair of outer cameras 131L and 131R is arranged at a prescribed distance from each other, and data of a pair of images obtained by these outer cameras 131L and 131R can also be used for stereoscopic display of the subject. Namely, outer cameras 131L and 131R function as what is called stereo cameras. Prescribed parallax in accordance with relative positional relation between outer camera 131L and outer camera 131R is present between the pair of input images obtained as a result of image pick-up by outer cameras 131L and 131R.

Meanwhile, an input image obtained as a result of image pick-up by inner camera 133 is basically used for non-stereoscopic display (two-dimensional display, normal display). Therefore, in game device 1, a pair of input images for stereoscopic display can be obtained by activating outer cameras 131L and 131R, and an input image for non-stereoscopic display can be obtained by activating inner camera 133.

In addition, in upper housing 2, stereoscopic vision volume 145 is provided on the right of upper LCD 110. This stereoscopic vision volume 145 is used for adjusting stereoscopic display on upper LCD 110.

A speaker (a speaker 151 shown in FIG. 5) serving as an audio generation device (audio generation means) is accommodated in upper housing 2. More specifically, sound emission holes 151L and 151R are arranged on respective left and right sides of upper LCD 110 arranged in a central portion of the inner main surface of upper housing 2. Voice and sound generated from speaker 151 is emitted toward the user through sound emission holes 151L and 151R communicating with speaker 151.

Meanwhile, lower LCD 120 is provided as a display portion (display means) in lower housing 3. Lower LCD 120 has a rectangular display region and it is arranged such that a direction in which its long side extends coincides with a direction in which a long side of lower housing 3 extends.

Though a display portion capable of providing stereoscopic display as will be described later may be adopted as lower LCD 120, in the present embodiment, a common display portion for providing non-stereoscopic display of various types of information or the like is adopted. Therefore, for example, a display portion of other appropriate types such as a display portion utilizing EL (Electro Luminescence) may be adopted as lower LCD 120. In addition, resolution of the display portion (display means) is appropriately designed, depending on an application or the like to be executed.

In lower housing 3, a control pad 154, a cross-shaped button 161, and button groups 142, 162 are provided as input means (input devices) for accepting an input operation from a user or the like. These input portions are provided on a main surface of lower housing 3 located on the inner side when upper housing 2 and lower housing 3 are folded. In particular, control pad 154 and cross-shaped button 161 are arranged at such positions as being readily operated with the user's left hand when he/she holds game device 1, and button group 162 is arranged at such a position as being readily operated with the user's right hand when he/she holds game device 1.

Control pad 154 mainly accepts an operation for adjusting stereoscopic display on game device 1. In particular, control pad 154 represents one example of an analog device capable of simultaneously accepting inputs having at least two degrees of freedom. More specifically, control pad 154 has a projection accepting a user's operation and it is structured to be able to change relative positional relation with respect to lower housing 3 at least in a vertical direction of the sheet surface and a horizontal direction of the sheet surface. An analog stick, a joystick or the like may be adopted, instead of control pad 154 shown in FIG. 2.

Cross-shaped button 161 is an input portion capable of independently operating two directions, and outputs a two-dimensional value having values in accordance with a user's button operation in respective directions.

Button group 162 includes four operation buttons 162A, 162B, 162X, and 162Y brought in correspondence with the vertical and horizontal directions of the sheet surface. Namely, button group 162 also corresponds to an input portion capable of independently operating two directions, and as the user operates operation buttons 162A, 162B, 162X, and 162Y brought in correspondence with the respective directions, a value indicating that operation state is output. This value indicating the operation state is also detected as an “operation input” which will be described later.

The operation input output from cross-shaped button 161 and/or button group 162 may be used for adjustment of stereoscopic display in game device 1. Alternatively, in various applications executed on game device 1, these operation inputs are used for such operations as select, enter and cancel involved with game proceeding.

Button group 142 includes a select button 142a, a HOME button 142b, a start button 142c, and a power button 142d. Select button 142a is typically used for selecting an application to be executed on game device 1. HOME button 142b is typically used for setting a menu application and/or various applications executed on game device 1 to an initial state. Start button 142c is typically used for starting execution of an application on game device 1. Power button 142d is used for turning ON/OFF power of game device 1.

A microphone (a microphone 153 shown in FIG. 5) serving as an audio obtaining device (audio obtaining means) is accommodated in lower housing 3. On the main surface of lower housing 3, a microphone hole 153a for microphone 153 to obtain sound around game device 1 is provided. It is noted that a position where microphone 153 is accommodated and a position of microphone hole 153a communicating with microphone 153 are not limited to those in the main surface of lower housing 3. For example, microphone 153 may be accommodated in hinge 4 and microphone hole 153a may be provided in the surface of hinge 4 at a position corresponding to a position where microphone 153 is accommodated.

In game device 1, in addition to control pad 154, cross-shaped button 161, and button groups 142, 162, a touch panel 122 is further provided as a pointing device serving as another input portion (input means). Touch panel 122 is attached to cover a screen of lower LCD 120, and when the user performs an input operation (a position indication operation or a pointing operation), touch panel 122 detects a value of a corresponding two-dimensional coordinate.

Namely, touch panel 122 accepts a user's position indication operation (a two-dimensional coordinate value) in a display region of lower LCD 120 and accepts change over time in the two-dimensional coordinate value while the position indication operation continues, that is, during a series of position indication operations.

Typically, a resistive touch panel can be adopted as touch panel 122. It is noted, however, that touch panel 122 is not limited to the resistive type and various pressing-type touch panels may also be adopted. In addition, touch panel 122 preferably has resolution (detection accuracy) as high as that of lower LCD 120 (display accuracy). It is noted that the resolution of touch panel 122 does not necessarily have to exactly be equal to the resolution of lower LCD 120.

A pointing operation onto touch panel 122 is normally performed by the user with the use of stylus 300. Instead of stylus 300, however, the pointing operation (input operation) can also be performed with a user's own finger or the like. As shown in FIGS. 2, 4A and 4B, an accommodation portion 176 for stylus 300 is provided in the rear surface of lower housing 3. Stylus 300 for an input operation onto touch panel 122 is normally stored in accommodation portion 176 and it is taken out by the user as necessary.

Instead of or in addition to touch panel 122, a mouse, a track ball, a pen tablet, or the like may be employed as the pointing device serving as accepting means for accepting a user's position indication operation. In addition, a pointer device capable of indicating a coordinate remotely from the display surface of the display portion (typically, a controller or the like of Wii®) may be adopted. In a case of using any device, the device is preferably configured to accept a position indication operation associated with a position within a display region of lower LCD 120.

As shown in FIGS. 3C, 3D, 4A, and 4B, an L button 162L is provided at a left end portion of the rear surface of lower housing 3, and an R button 162R is provided at a right end portion of the rear surface of lower housing 3. L button 162L and R button 162R are used for such an operation as select in various applications executed on game device 1.

As shown in FIG. 3C, sound volume 144 is provided on a left side surface of lower housing 3. Sound volume 144 is used for adjusting a volume of the speaker (speaker 151 shown in FIG. 5) mounted on game device 1.

As shown in FIG. 3D, a wireless switch 143 is provided on the right side surface of lower housing 3. Wireless switch 143 switches wireless communication in game device 1 between an ON state (an active state) and an OFF state (an inactive state).

A game card 171 and/or a memory card 173 can be attached to game device 1.

Namely, as shown in FIG. 4B, a game card slot 170 for attaching game card 171 is provided in the rear surface of lower housing 3. In the rear of game card slot 170, an interface for electrical connection between game device 1 and game card 171 is provided. Game card slot 170 is configured such that game card 171 is removably attached. Game card 171 retains an application program, a game program (both of which include an instruction set), or the like.

In addition, as shown in FIG. 3C, a memory card slot 172 for attaching memory card 173 is provided in the left side surface of lower housing 3. In the rear of memory card slot 172, an interface for electrical connection between game device 1 and memory card 173 is provided. Memory card slot 172 is configured such that memory card 173 is removably attached. Memory card 173 is used for reading a program or image data obtained from another information processing apparatus or game device, storage (saving) of data of an image picked up and/or processed by game device 1, or the like. Game card 171 is implemented by a non-volatile recording medium such as an SD (Secure Digital) card.

In game device 1, various display devices for presenting an operation state or the like to the user are provided. More specifically, in lower housing 3 and upper housing 2, an indicator group 147 consisting of a plurality of LEDs (Light Emitting Diodes) is provided as a display portion (display means). Indicator group 147 includes a stereoscopic display indicator 147a, a notification indicator 147b, a wireless indicator 147c, a power supply indicator 147d, and a charge indicator 147e. Stereoscopic display indicator 147a is provided on the main surface of upper housing 2 and other indicators are provided on the main surface or on the side surface of lower housing 3.

Stereoscopic display indicator 147a gives notification of whether stereoscopic display is provided on upper LCD 110 or not. Typically, while stereoscopic display on upper LCD 110 is active, stereoscopic display indicator 147a illuminates.

Notification indicator 147b gives notification of whether information to be notified of the user is present or not. Typically, when an e-mail unread by the user is present or when some message is received from various servers, notification indicator 147b illuminates.

Wireless indicator 147c gives notification of a state of wireless communication in game device 1. Typically, when wireless communication is active, wireless indicator 147c illuminates.

Power supply indicator 147d gives notification of a power supply state in game device 1. Game device 1 contains a not-shown battery (typically, accommodated in lower housing 3), and it is mainly driven by electric power from this battery. Therefore, power supply indicator 147d gives notification of a state of power ON in game device 1 and/or a state of charge of the battery. Typically, while power of game device 1 is turned ON (in the ON state) and a state of charge of the battery is sufficiently high, power supply indicator 147d illuminates in green, and while power of game device 1 is turned ON (in the ON state) and a state of charge of the battery is low, it illuminates in red.

Charge indicator 147e gives notification of a state of charge of the battery described above. Typically, when a charge adapter (not shown) or the like is attached to game device 1 and the contained battery is being charged, charge indicator 147e illuminates. It is noted that the charge adapter is connected to a charge terminal 174 provided in the rear surface of game device 1, as shown in FIG. 4B.

In addition, game device 1 incorporates an infrared communication function and an infrared port 179 is provided on the rear surface of game device 1. This infrared port 179 projects/receives infrared rays, which are carrier waves for data communication.

In the front surface of game device 1, hooks 31, 32 for connection to a strap for suspending game device 1 are provided.

On the front surface of lower housing 3, a connection terminal 158 for connecting a headphone and/or a microphone is provided.

### D. Electrical Configuration of Game Device

An electrical configuration of game device 1 will now be described.

Referring to FIG. 5, game device 1 includes an operation processing unit 100, upper LCD 110, lower LCD 120, touch panel 122, outer cameras 131L, 131R, inner camera 133, a wireless module 134, a non-volatile memory 136, a main memory 138, a microcomputer 140, button group 142, sound volume 144, stereoscopic vision volume 145, a power supply management IC (Integrated Circuit) 146, indicator group 147, an acceleration sensor 148, an interface circuit 150, speaker 151, a headphone amplifier 152, microphone 153, connection terminal 158, cross-shaped button 161, button group 162, game card slot 170, memory card slot 172, and an infrared module 178. In addition, game device 1 includes a battery and a power supply circuit that are not shown.

Operation processing unit 100 is responsible for overall control of game device 1. More specifically, operation processing unit 100 realizes various types of processing including control of stereoscopic display on upper LCD 110 by executing firmware (an instruction set) stored in advance in non-volatile memory 136, a program (an instruction set) or data read from game card 171 attached to game card slot 170, a program (an instruction set) or data read from memory card 173 attached to memory card slot 172, or the like.

It is noted that, in addition to a case where a program (an instruction set) executed by operation processing unit 100 is provided through game card 171 or memory card 173, a program may be provided to game device 1 through an optical recording medium such as a CD-ROM or a DVD. Moreover, a program may be provided from a server device (not shown) connected through a network.

More specifically, operation processing unit 100 includes a CPU (Central Processing Unit) 102, a GPU (Graphical Processing Unit) 104, a VRAM (Video Random Access Memory) 106, and a DSP (Digital Signal Processor) 108. Processing in each unit will be described later. In addition, operation processing unit 100 exchanges data with each unit.

Each of outer cameras 131L, 131R and inner camera 133 is connected to operation processing unit 100, and outputs an input image obtained as a result of image pick-up to operation processing unit 100 in response to an instruction from operation processing unit 100. Each of these cameras includes image pick-up elements such as CCD (Charge Coupled Device) or CIS (CMOS Image Sensor) and a peripheral circuit for reading image data (input image) obtained by the image pick-up elements.

Wireless module 134 exchanges data with another game device 1 or some information processing apparatus through a wireless signal. By way of example, wireless module 134 communicates data with another device under a wireless LAN scheme complying with such standards as IEEE802.11a/b/g/n.

Non-volatile memory 136 stores firmware or the like necessary for a basic operation of game device 1 and a code describing the firmware is developed on main memory 138. As CPU 102 of operation processing unit 100 executes the code developed on main memory 138, basic processing in game device 1 is realized. In addition, non-volatile memory 136 may store data on various parameters set in advance in game device 1 (pre-set data). By way of example, non-volatile memory 136 is implemented by a flash memory.

Main memory 138 is used as a work area or a buffer area for operation processing unit 100 to perform processing. Namely, main memory 138 temporarily stores a program (a code) or data necessary for processing by operation processing unit 100. By way of example, main memory 138 is implemented by a PSRAM (Pseudo-SRAM).

Microcomputer 140 mainly provides processing involved with a user interface. More specifically, microcomputer 140 is connected to operation processing unit 100 as well as to button group 142, sound volume 144, stereoscopic vision volume 145, power supply management IC 146, indicator group 147, and acceleration sensor 148. Microcomputer 140 senses a user's button operation or the like, outputs the result of sensing to operation processing unit 100, and causes an indicator for notifying the user of various types of information to illuminate, in response to a signal from operation processing unit 100.

In addition, microcomputer 140 has a real time counter (RTC: Real Time Clock) 141. Real time counter 141 is a part providing a time-counting function, and counts time in a predetermined cycle. The result of counting is successively output to operation processing unit 100. Operation processing unit 100 can also calculate the current time (date) or the like based on a count value counted by real time counter 141.

Power supply management IC 146 causes supply of electric power from a power supply (typically, the battery described above) mounted on game device 1 to each unit and controls an amount of supply thereof.

Acceleration sensor 148 detects displacement of game device 1 and the result of detection is output to operation processing unit 100 through microcomputer 140. The result of detection by acceleration sensor 148 is utilized in a program (a game application) executed on game device 1.

Infrared module 178 establishes wireless communication (infrared communication) with another game device 1. Wireless communication established by this infrared module 178 is narrower in coverage than wireless communication through wireless module 134. It is noted that infrared rays which are carrier waves for infrared communication are projected/received through infrared port 179 (see FIG. 4B).

Interface circuit 150 is connected to operation processing unit 100 as well as to speaker 151, headphone amplifier 152, microphone 153, control pad 154, and touch panel 122. More specifically, interface circuit 150 includes an audio control circuit (not shown) for controlling speaker 151, headphone amplifier 152 and microphone 153 and a touch panel control circuit (not shown) for controlling touch panel 122.

Speaker 151 amplifies an audio signal from interface circuit 150 to output voice and sound through sound emission holes 151L and 151R. Headphone amplifier 152 amplifies an audio signal from interface circuit 150 to output voice and sound from a connected headphone. Microphone 153 senses user's voice or the like uttered toward game device 1 to output an audio signal indicating sensed voice to interface circuit 150.

As described above, the audio control circuit constituting interface circuit 150 carries out A/D (analog/digital) conversion of an analog audio signal sensed by microphone 153 to output the resultant digital audio signal to operation processing unit 100, and carries out D/A (digital/analog) conversion of a digital audio signal generated by operation processing unit 100 or the like to output the resultant analog audio signal to speaker 151 and/or a connected headphone.

In addition, the touch panel control circuit constituting interface circuit 150 generates touch position data indicating a position where the user performed an input operation (a pointing operation) in response to a detection signal from touch panel 122 and outputs the data to operation processing unit 100. Namely, touch panel 122 outputs an operation input (touch position data) in accordance with a two-dimensional coordinate value corresponding to the position pointed on a touch surface.

Game card slot 170 and memory card slot 172 are each connected to operation processing unit 100. Game card slot 170 reads and writes data from and into attached game card 171 through a connector in response to a command from operation processing unit 100. Memory card slot 172 reads and writes data from and into attached memory card 173 through a connector in response to a command from operation processing unit 100.

Lower LCD 120 and upper LCD 110 each display an image in response to a command from operation processing unit 100. In a typical manner of use of game device 1, an image for accepting various operations is displayed on lower LCD 120 and stereoscopic display is provided on upper LCD 110.

### E. Configuration for Providing Stereoscopic Display

A configuration for providing stereoscopic display in game device 1 will now be described.

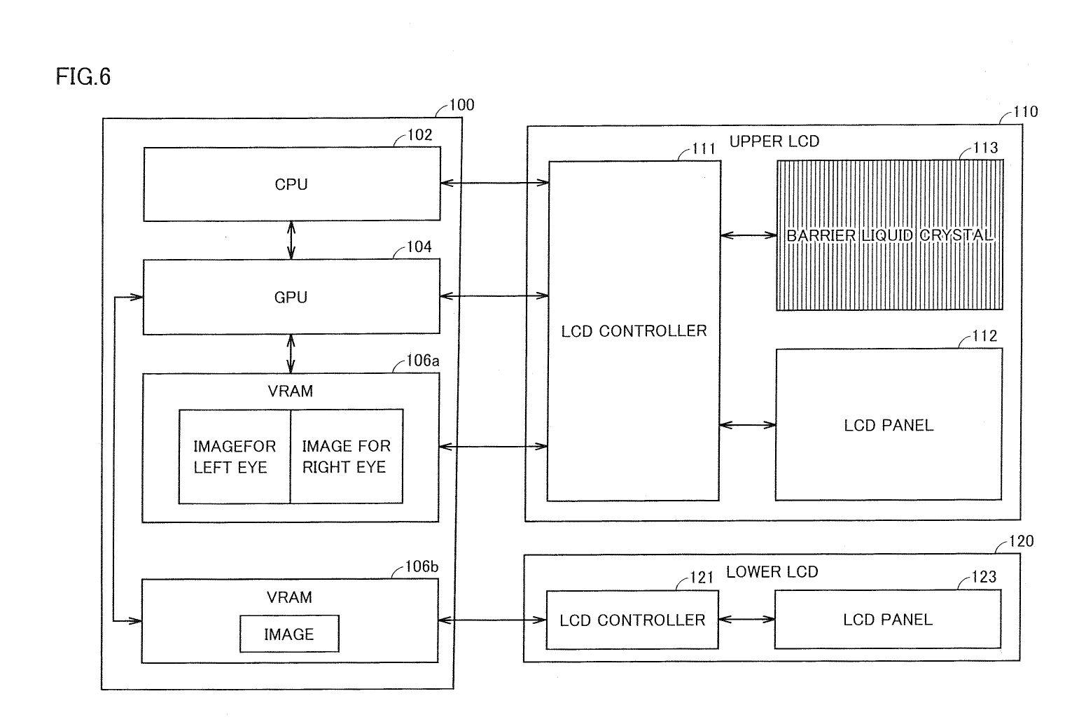

Referring to FIG. 6, operation processing unit 100 includes GPU 104 for mainly performing processing for displaying images on upper LCD 110 and lower LCD 120 respectively (image processing), in addition to CPU 102. GPU 104 has a processing circuit specialized for image processing and successively generates images to be displayed on upper LCD 110 and lower LCD 120 respectively in response to a command from CPU 102. These images are transferred to a VRAM 106a for upper LCD 110 and a VRAM 106b for lower LCD 120 respectively.

Here, a pair of images (an image for left eye and an image for right eye) for stereoscopic display on upper LCD 110 is written in VRAM 106a independently of each other. In contrast, since two-dimensional display (non-stereoscopic display) is provided on lower LCD 120, a single image is written in VRAM 106b.

Upper LCD 110 includes an LCD controller 111, an LCD panel 112, and a barrier liquid crystal 113. In contrast, lower LCD 120 includes an LCD controller 121 and an LCD panel 123.

A structure of upper LCD 110 is further described.

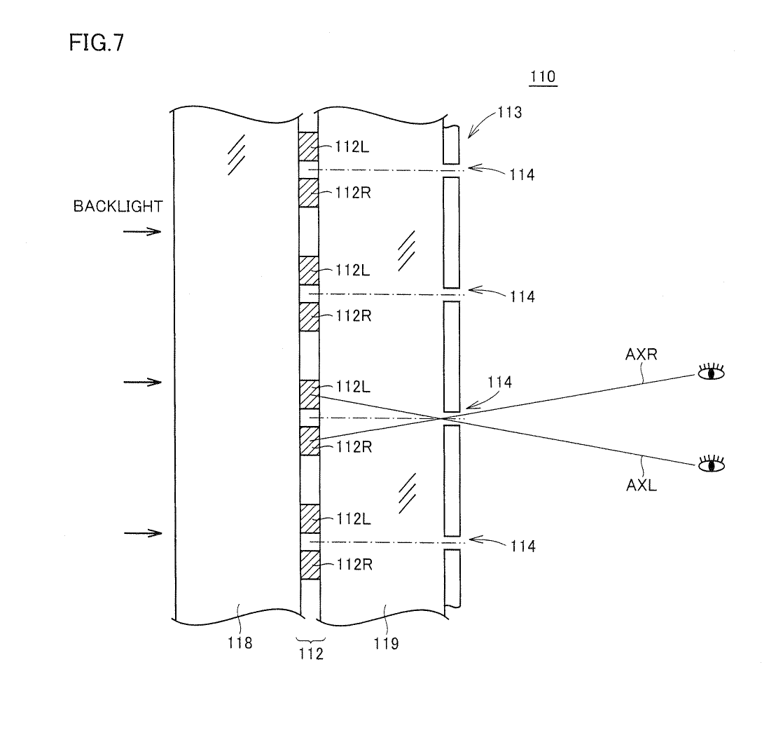

FIG. 7 shows a structure of a parallax barrier type liquid crystal display device as a typical example of upper LCD 110. Upper LCD 110 includes LCD panel 112 arranged between a glass substrate 118 and a glass substrate 119.

LCD panel 112 includes a left eye pixel group 112L and a right eye pixel group 112R. A not-shown backlight is provided on a side of glass substrate 118 opposite to glass substrate 119 and light from this backlight is emitted toward left eye pixel group 112L and right eye pixel group 112R. Left eye pixel group 112L and right eye pixel group 112R function as a spatial light modulator for adjusting light from the backlight. Here, each pixel in left eye pixel group 112L and each pixel in right eye pixel group 112R are alternately arranged.

Barrier liquid crystal 113 representing a parallax optical system is provided on a side opposite to the side where glass substrate 118 is in contact with left eye pixel group 112L and right eye pixel group 112R. In this barrier liquid crystal 113, a plurality of slits 114 are provided in rows and columns at prescribed intervals. Left eye pixel group 112L and right eye pixel group 112R are arranged symmetrically to each other, with an axis passing through a central position of each slit 114 and perpendicular to a surface of glass substrate 118 serving as the reference. By appropriately designing positional relation with the slit, of each set of left eye pixel group 112L and right eye pixel group 112R brought in correspondence with each slit, the user visually recognizes only left eye pixel group 112L with his/her left eye and visually recognizes only right eye pixel group 112R with his/her right eye.

Namely, each slit 114 included in barrier liquid crystal 113 restricts a field of view of each of the user's right and left eyes to a corresponding angle. Consequently, only left eye pixel group 112L is present in a line of sight AXL of the user's left eye, while only right eye pixel group 112R is present in a line of sight AXR of the user's right eye.

Here, by causing left eye pixel group 112L and right eye pixel group 112R to display a pair of images having prescribed parallax, an image having prescribed parallax can be presented to the user. By displaying such a pair of images having prescribed parallax, the user feels as if he/she stereoscopically viewed a subject. Hereinafter, a surface of barrier liquid crystal 113 on the user side, that is, a surface on which this image is actually displayed, is also referred to as a display surface (of upper LCD 110).

More specifically, as shown in FIG. 6, GPU 104 successively writes an image for left eye and an image for right eye, by designating an address in VRAM 106a. LCD controller 111 successively reads image data in each column from the address of interest in VRAM 106a such that images in the direction of column constituting the image for left eye and the image for right eye written in VRAM 106a are alternately displayed in alignment on LCD panel 112, and drives LCD panel 112.

It is noted that upper LCD 110 can also provide two-dimensional display, that is, non-stereoscopic display, of an image. In this case, a method of inactivating barrier liquid crystal 113 and a method of setting parallax between the image for left eye and the image for right eye used for display to substantially zero, by providing a command to LCD controller 111, are available.

In the case of the former method, since a plurality of slits 114 provided in barrier liquid crystal 113 are inactivated, light from left eye pixel group 112L and right eye pixel group 1128 is substantially incident on the user's left and right eyes. In this case, resolution for the user is substantially twice as high as resolution in stereoscopic display.

In the case of the latter method, since the image visually recognized by the user's left eye and the image visually recognized by the user's right eye are substantially equally controlled, the user visually recognizes the same image with his/her left and right eyes.

Meanwhile, non-stereoscopic display is provided on lower LCD 120. Namely, GPU 104 successively writes an image to be displayed, by designating an address in VRAM 106b, and LCD controller 121 successively reads images written in VRAM 106b and drives LCD panel 123.

Though a parallax barrier type display device has been exemplified in FIG. 7 by way of a typical example of a display portion capable of providing stereoscopic display, for example, a lenticular type display device or the like may also be adopted. According to such a type, a display area for an image for left eye and a display area for an image for right eye are arranged in a certain pattern (typically, alternately).

It is noted that such a form that an image for left eye and an image for right eye are alternately displayed with a display area for the image for left eye and a display area for the image for right eye being common may be adopted, as in the method of utilizing shutter glasses (time-division type).

### F. Control Logic Involved With Stereoscopic Display

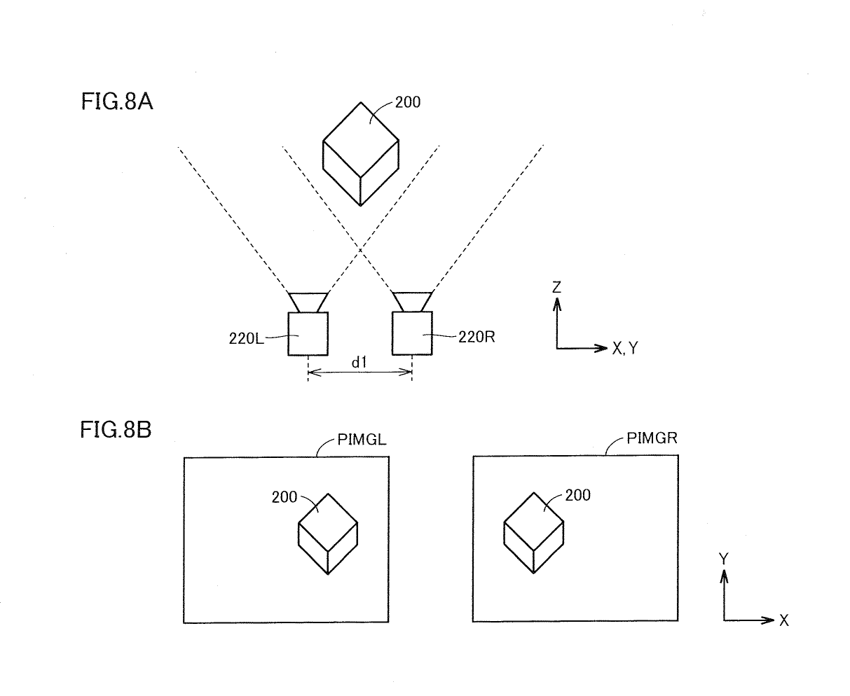

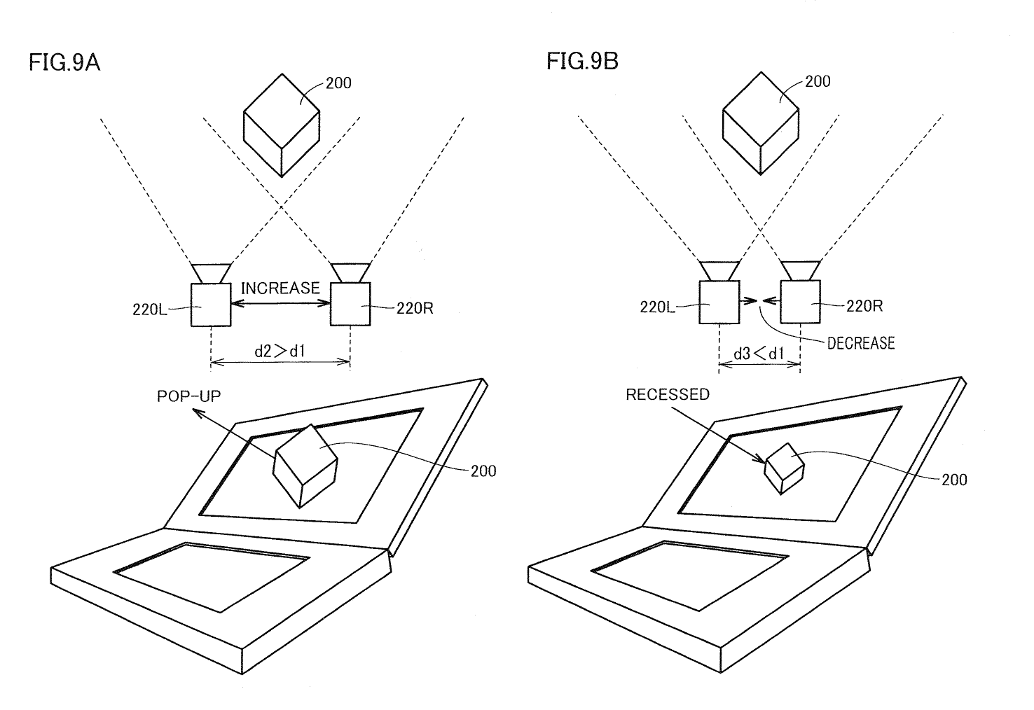

Referring next to FIGS. 8A, 8B, 9A, and 9B, a control logic involved with stereoscopic display in game device 1 will be described. As described above, stereoscopic display can be realized by using a pair of images (stereo images) having prescribed parallax, and a known method can be adopted as a method of generating this stereo image. In the following, processing in generating a stereo image by virtually picking up (rendering) an image of an object arranged in a virtual space by using a virtual camera will be described. Instead of such a configuration, a pair of images (stereo images) can also be obtained by using a pair of outer cameras 131L and 131R (see FIG. 3A) to pick up an image of a real subject.

FIG. 8A shows a case where object 200 is arranged in a virtual space and a pair of virtual cameras 220L and 220R is used to pick up (render) an image of this object 200. It is noted that relative positional relation of object 200 with respect to virtual cameras 220L and 220R and a distance d1 between virtual camera 220L and virtual camera 220R can arbitrarily be set by an application or the like.

In the description below, a straight line connecting the pair of virtual cameras 220L and 220R to each other is assumed as corresponding to a horizontal direction of the display surface of the display portion (upper LCD 110). Here, the horizontal direction is referred to as an X direction, a vertical direction is referred to as a Y direction, and a camera direction of each virtual camera 220L, 220R (a direction of optical axis of image pick-up) is referred to as a Z direction (to be understood similarly hereafter).

FIG. 8B shows one example of a pair of input images (stereo images) obtained in positional relation as shown in FIG. 8A. Namely, as virtual camera 220L renders object 200, an input image for left eye PIMGL is generated, and as virtual camera 220R renders object 200, an input image for right eye PIMGR is generated.

When input image for left eye PIMGL and input image for right eye PIMGR are compared with each other, it can be seen that a position of object 200 in input image PIMGL and a position of object 200 in input image PIMGR are different from each other. Namely, in input image PIMGL, an object image representing object 200 is located relatively on the right, and in input image PIMGR, an object image representing object 200 is located relatively on the left.

By displaying a pair of input images (stereo images) having such parallax on a display surface of upper LCD 110, the user can stereoscopically visually recognize that object 200. An amount of parallax provided to such a pair of input images varies, depending on magnitude of distance d1 between virtual camera 220L and virtual camera 220R (FIG. 8A).

More specifically, as a distance between virtual camera 220L and virtual camera 220R increases (d2>d1) as shown in FIG. 9A, an amount of parallax provided to input image PIMGL and input image PIMGR also increases. Consequently, the user visually recognizes object 200 as being present toward the user relative to the display surface of upper LCD 110. So to speak, the user feels as if the object image of object 200 “popped up” from the display surface.

In contrast, as a distance between virtual camera 220L and virtual camera 220R decreases (d3<d1) as shown in FIG. 9B, an amount of parallax provided to input image PIMGL and input image PIMGR also decreases. Consequently, the user visually recognizes object 200 as being present toward the rear relative to the display surface of upper LCD 110. So to speak, the user visually recognizes the object image of object 200 as if it were “recessed” in the display surface.

Thus, by adjusting parallax provided to a pair of images displayed on upper LCD 110, a position of presence of an object as visually recognized by the user in a direction of depth of the display portion can be controlled. Namely, by controlling an amount of parallax as appropriate, the user can be caused to visually recognize presence of an object at an intended distance from a display portion.

When an amount of parallax provided to a pair of images is set to zero, the same image is incident on the user's right and left eyes, and hence an object is two-dimensionally displayed with respect to the display surface.

In connection with the method shown in FIGS. 8A and 8B, a method of adjusting an amount of parallax to be provided to a pair of images displayed with respect to the display portion by virtually picking up an image of an object has been described, however, a position of an object visually recognized by the user can also be adjusted by using a pair of images provided with an amount of parallax at a certain constant value to change relative display positions of these images with respect to the display surface.

### G. Position Detection and Associated Processing

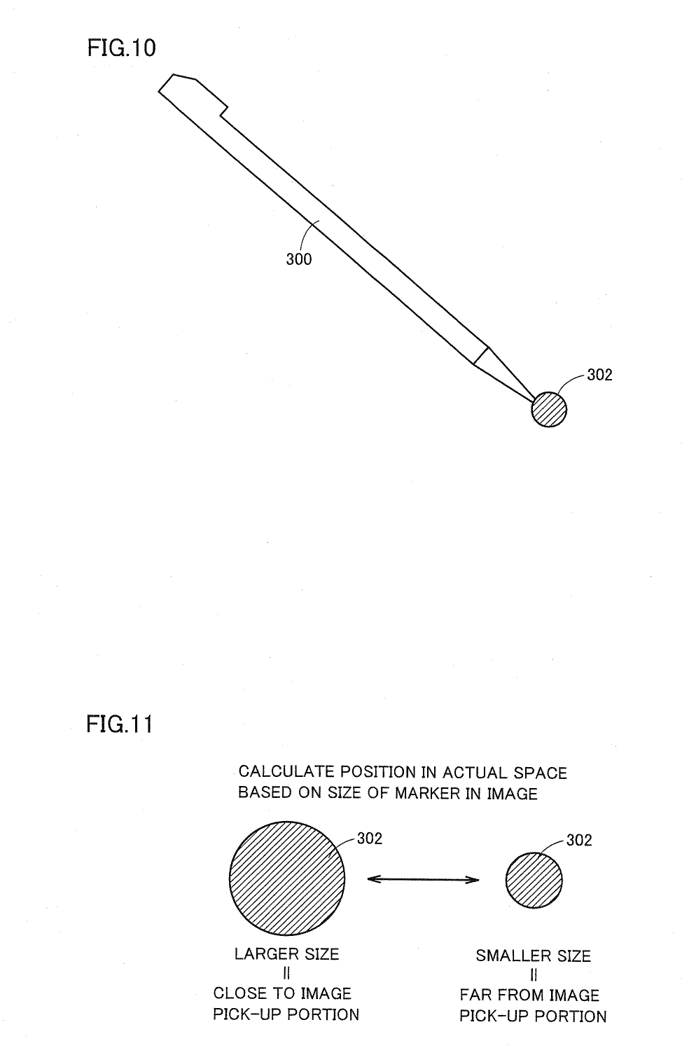

Processing for detecting a position where the user's operation has been performed will now be described with reference to FIGS. 10 to 13.

In game device 1, an image obtained by image pick-up by the image pick-up portion, of an indicator associated with the user's operation, is used to detect a position. More specifically, a marker for position detection provided with a feature allowing extraction of a position by using an image processing technique is employed as an indicator.

As such a marker, a member to which surface such a color as not being present in a real world (typically, a fluorescent color) is applied, a member provided with a predetermined design (pattern) on its surface, or the like is employed. By employing such a member to extract a position and a region where a specific color or design is present from an image picked up by the image pick-up portion, a position of the marker can be calculated.

As shown in FIG. 10, it is assumed that a spherical marker 302 is attached as the indicator, to a tip end of stylus 300 according to the present embodiment. It is noted that this marker 302 may directly be attached to a user's finger or the like.

The reason why marker 302 representing the indicator has a spherical shape is to measure a distance from the image pick-up portion based on a size in an image, as will be described later. Namely, by adopting spherical marker 302, in an image obtained by the image pick-up portion, the same shape (circle) can always be maintained without being affected by relative positional relation between the image pick-up portion and marker 302. Thus, a size of an image corresponding to marker 302 in the image can be measured in a stable manner.

Referring to FIG. 11, in game device 1, based on an image of an indicator (marker 302) of which image is picked up by the image pick-up portion, a relative position of the indicator with respect to the image pick-up portion is calculated. More specifically, based on a size of an image representing the marker in an image picked up by the image pick-up portion, a position of marker 302 in the direction of depth (the Z direction) of the display portion (upper LCD 110) is calculated.

Namely, a greater size of marker 302 in an image obtained by the image pick-up portion means being close to the image pick-up portion, and on the contrary, a smaller size of marker 302 in an image obtained by the image pick-up portion means being far from the image pick-up portion.

In game device 1, inner camera 133 or outer cameras 131L and 131R pick(s) up an image of a range where marker 302 is present, and based on a position and a size of a region corresponding to marker 302 in the image obtained in this image pick-up, a position in a coordinate system with the image pick-up portion serving as the reference is calculated. Then, after a position in the coordinate system with the image pick-up portion serving as the reference is converted to a position in a coordinate system with the display portion (upper LCD 110) serving as the reference, whether a position of an object stereoscopically displayed with respect to the display portion and a calculated position of marker 302 overlap with each other or not, that is, whether both of them collide against each other or not, is determined. Finally, game processing proceeds based on results of this determination. More specifically, processing is performed as in the following procedure.

1. Calculation of a position of display of an object visually recognized by the user (an amount of pop-up/an amount of recess)

2. Calculation of a position of the marker

3. Determination of collision

4. Performing game processing in accordance with results of collision determination (change in position of display of an object)

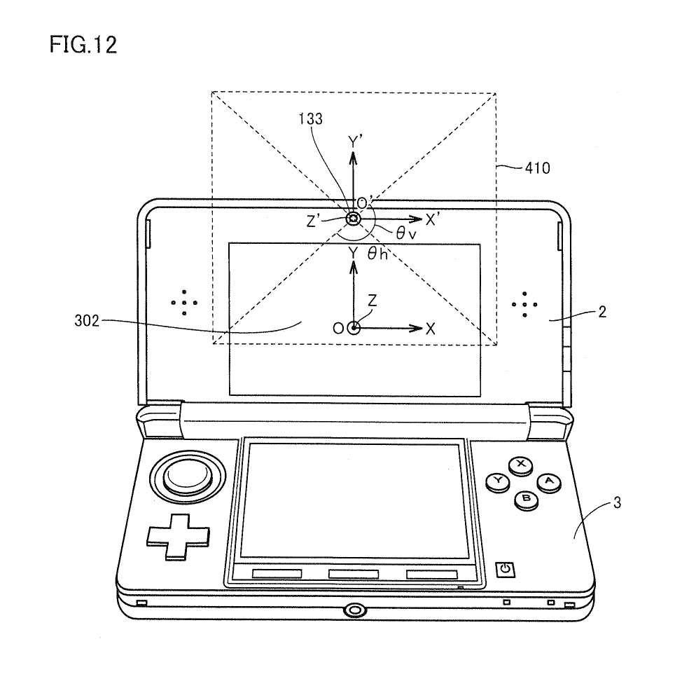

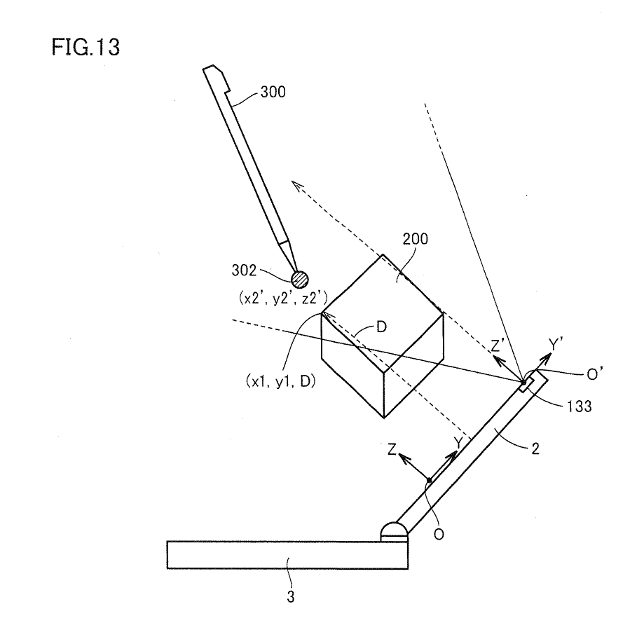

Details of such processing will be described hereinafter with reference to FIGS. 12 and 13.

(g1: Calculation of Display Position (Amount of Pop-Up/Amount of Recess))

Initially, a coordinate system used for calculating a position is set as follows. Namely, as shown in FIGS. 12 and 13, as a coordinate system for the display portion (upper LCD 110), with a central point O in the display surface of upper LCD 110 being defined as an origin, a horizontal direction is set as an X axis, a vertical direction is set as a Y axis, and a direction of depth is set as a Z axis. For the sake of convenience of calculation, right in the horizontal direction is assumed as a positive direction of the X axis, upward in the vertical direction is assumed as a positive direction of the Y axis, and front in the direction of depth is assumed as a positive direction of the Z axis. Therefore, central point O(x, y, z)=(0, 0, 0). An actual distance (for example, meter) is assumed as a unit in this coordinate system.

Then, as shown in FIGS. 12 and 13, as a coordinate system for the image pick-up portion (inner camera 133), with a central point O′ of inner camera 133 being defined as an origin, a horizontal direction along the surface of upper housing 2 is set as an X′ axis and a vertical direction is set as a Y′ axis. Then, a Z′ axis is set in parallel to the Z axis representing the coordinate system for upper LCD 110. For the sake of convenience of calculation, right in the horizontal direction is assumed as a positive direction of the X′ axis, upward in the vertical direction is assumed as a positive direction of the Y′ axis, and front in the direction of depth is assumed as a positive direction of the Z′ axis.

As will be described later, since correspondence between the coordinate system for the image pick-up portion (inner camera 133) (an X′-Y′-Z′ coordinate system) and the coordinate system for the display portion (upper LCD 110) (an X-Y-Z coordinate system) has already been known in advance, a position calculated in the X′-Y′-Z′ coordinate system can readily be converted to a position in the X-Y-Z coordinate system.

Initially, a position of display of object 200 in the direction of depth (Z axis) of the display portion is calculated. Namely, an amount of pop-up or an amount of recess of object 200 visually recognized by the user is calculated.

More specifically, a distance [m] between the human's left and right eyes is denoted as A, an amount of parallax [m] provided to object 200 on the display surface is denoted as B, and a distance from the display surface of upper LCD 110 to the user's eyes is denoted as C [m], a distance (an amount of pop-up/an amount of recess) D [m] from the display surface where stereoscopically displayed object 200 is visually recognized is calculated as in the equation (1).

D=B/(A+B)×C (1)

Here, assuming that the central point in the display surface of the display portion (upper LCD 110) is defined as the origin (0, 0) and a position of display of object 200 on the display surface is at (x1, y1), a position of display of object 200 in the X-Y-Z coordinate system can be expressed as in the equation (2).

(x1,y1,z1)=(x1,y1,D) (2)

Since distance A between the human's left and right eyes and distance B from the display surface to the user's eyes in the equation (1) varies among individuals, distance D from the display surface is different (varies) for each user. It is noted that a prescribed design value is given in advance to these distances A and B. Therefore, a position of display of the object (x1, y1, D) should be handled as including error. Specifically, such a method as setting a margin in consideration of such error for a threshold value or the like for determining whether collision has occurred or not in collision determination processing as will be described later is possible.

(g2: Calculation of Position of Marker)

Then, a position of the marker is calculated based on the image picked up by the image pick-up portion.

Initially, in a case where marker 302 is present at a position at a unit distance from the image pick-up portion, a size of a region corresponding to marker 302 in the image obtained by image pick-up by the image pick-up portion is assumed as F [m]. Then, at a certain time point, if a size of the region corresponding to marker 302 in the image obtained by image pick-up by the image pick-up portion attains to E [m], a distance G [m] from the image pick-up portion to marker 302 is calculated as in the equation (3).

G=E/F (3)

Here, sizes E and F are calculated by using image processing to extract the number of pixels occupied by the region corresponding to the marker in the image obtained by the image pick-up portion, a diameter of that region, or the like. If marker 302 is present at the end of an image pick-up range of the image pick-up portion and hence marker 302 is not in a perfect shape, the size thereof cannot accurately be calculated. In such a case, image interpolation or the like is carried out to modify the image of the region representing marker 302 and then the size is calculated.

In addition, assuming that a coordinate of the region corresponding to marker 302 in the image obtained by the image pick-up portion is (x2″, y2″), a position (x2′, y2′, z2′) of marker 302 in the X′-Y′-Z′ coordinate system is located on a vector Vm expressed in the equation (4).

Vm(x′,y′,z′)=({tan(θh/2)×x2″}/(Ph/2),{tan(θv/2)×y2″}/(Pv/2),1) (4)

It is noted that resolution of the image pick-up portion is assumed as Ph [pixels]×Pv [pixels], a horizontal angle of view thereof is assumed as θh [°], and a vertical angle of view thereof is assumed as θv [°].

The equation (3) corresponds to a position in the X′-Y′-Z′ coordinate system in a case where marker 302 is present at a position at a unit distance from the image pick-up portion (a case of z=1). Assuming magnitude (norm) of vector Vm shown in the equation (4) as H, the position (x2′, y2′, z2′) of marker 302 in the X′-Y′-Z′ coordinate system is calculated as in the equation (5).

(x2′,y2′,z2′)=({tan(θh/2)×x2″×G/H56 /(Ph/2),{tan(θv/2)×y2″×G/H}/(Pv/2),G/H) (5)

In addition, assuming an amount of offset between central point O in the X-Y-Z coordinate system and central point O′ in the X′-Y′-Z′ coordinate system as (Xf, Yf, Zf), the position (x2, y2, z2) of marker 302 in the X-Y-Z coordinate system is calculated as in the equation (6).

(x2,y2,z2)=(x2′+Xf,y2′+Yf,z2′+Zf) (6)

(g3: Collision Determination)

Based on relation between a shape of a stereoscopically displayed object and the calculated position of marker 302, collision determination is made. Namely, a degree of proximity between a position of display of object 200 expressed as in the equation (2) above and a position of marker 302 expressed as in the equation (6) above is evaluated. A known algorithm can be used for such processing for collision determination.

(g4: Game Processing Performed)

In accordance with the results of determination in collision determination described above, a position or the like of a displayed object is changed. For example, a position of an object that looks like popping up is changed or such an effect as notifying the user of touching the object is produced. As will be described later, such contents are changed as appropriate in accordance with contents of each applied application.

### H. Image Pick-up Portion

The image pick-up portion for picking up an image of marker 302 for position detection representing the indicator will now be described.

(h1: Inner Camera)

As described above, basically, an image of a region including marker 302 is picked up by inner camera 133 (FIG. 1) and a region corresponding to marker 302 included in the image obtained by that image pick-up is extracted. Namely, game device 1 has upper housing 2 provided with upper LCD 110 representing the display portion on one surface, and inner camera 133 representing the image pick-up portion used for calculating a position of the marker is provided in the surface of upper housing 2 the same as the surface where the display portion is provided. By thus using inner camera 133, the user's operation can appropriately be detected.

Depending on a position of attachment and/or specifications of inner camera 133, the field of view thereof may not be able to cover the whole amount of pop-up of an object. In such a case, as shown below, a lens is additionally provided to inner camera 133 or an alternative camera is made use of, so that the image pick-up range can also be expanded.

(h2: Omnidirectional Camera)

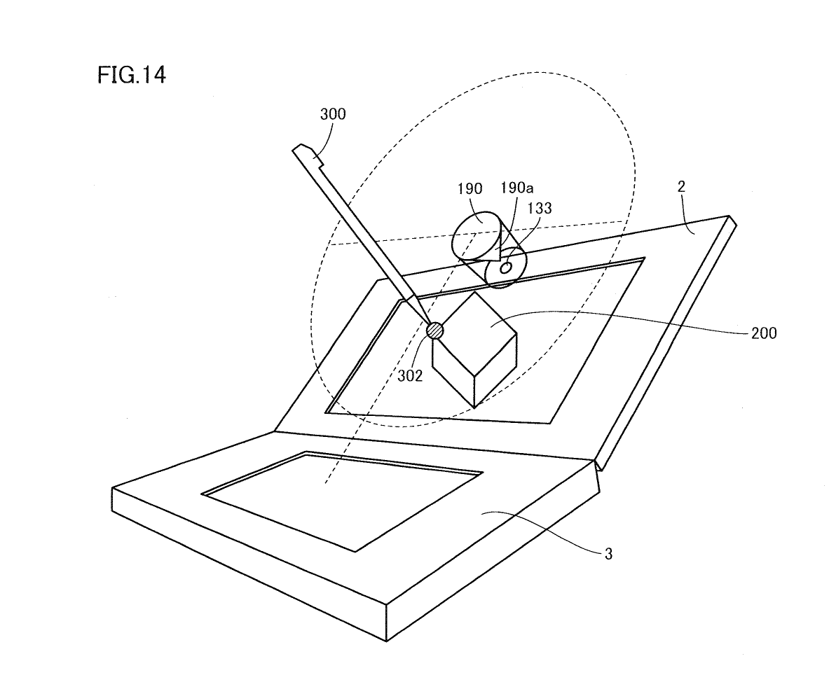

FIG. 14 shows a configuration example where an omnidirectional lens 190 is attached on the side of an image pick-up surface of inner camera 133 attached to upper housing 2. Omnidirectional lens 190 is a lens removably provided in inner camera 133 representing the image pick-up portion, for guiding an image all around inner camera 133 to inner camera 133.

More specifically, omnidirectional lens 190 includes a hyperboloidal mirror 190a, which reflects light from all around omnidirectional lens 190 and guides the light to the lens of inner camera 133. Thus, image pick-up around substantially 360° of omnidirectional lens 190 can be carried out. Namely, by combining omnidirectional lens 190 and inner camera 133 with each other, an operation performed by the user around upper housing 2 can optically be detected.

By thus attaching omnidirectional lens 190 to inner camera 133, an omnidirectional camera is implemented. It is noted that simply attaching omnidirectional lens 190 leads to a distorted picked-up image and hence the image should be corrected and then position calculation processing as described above should be performed.

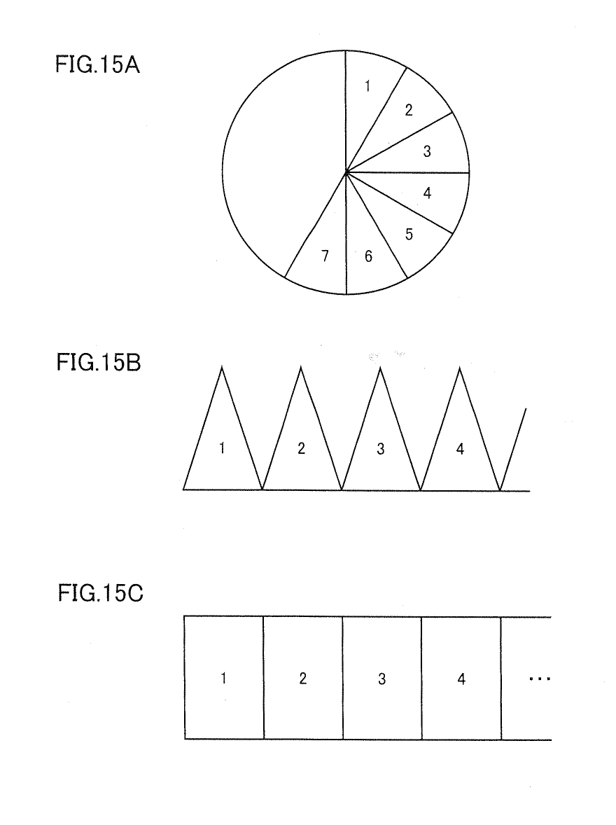

More specifically, according to the configuration in FIG. 14, inner camera 133 obtains an omnidirectional image as shown in FIG. 15A. By developing such a circular omnidirectional image, a panoramic image as shown in FIG. 15B is generated. Further, by performing image processing including a prescribed interpolation logic, a square picked-up image as shown in FIG. 15C is generated. By subjecting this picked-up image shown in FIG. 15C to marker position calculation processing as described above, the user's operation can be sensed.

Though FIG. 14 shows an example where omnidirectional lens 190 is attached to inner camera 133 to implement the omnidirectional camera, instead of inner camera 133, an omnidirectional sensor may be attached to upper housing 2.

(h3: Wide-Angle Lens)

Though an image all around inner camera 133 can be picked up by using the omnidirectional camera (omnidirectional lens) as shown in FIG. 14, dedicated image processing as shown in FIG. 15 is required. Therefore, by attaching a wide-angle lens to inner camera 133, the user's operation can be detected over a wider field of view with a more simplified configuration.

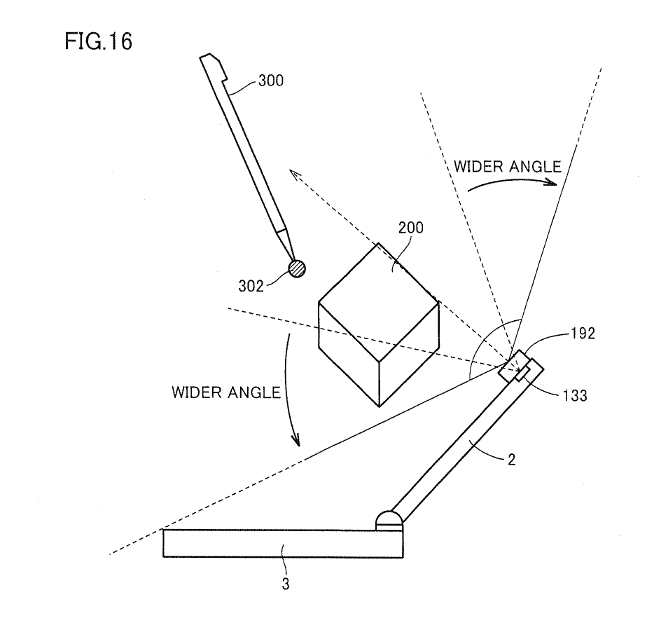

In game device 1 shown in FIG. 16, a wide-angle lens 192 is configured to be removably attached to inner camera 133 attached to upper housing 2. As such wide-angle lens 192 is attached in front of inner camera 133, a field of view (angle of view) thereof is expanded (widened) and the user's operation can be sensed over a wider range.

An attachment lens readily attached to upper housing 2 is preferred as wide-angle lens 192. Any optical system can be adopted as such wide-angle lens 192, so long as it is an optical system capable of expanding the field of view (angle of view) of inner camera 133. For example, what is called a wide-angle lens, a super-wide-angle lens, a fish-eye lens, and the like can be employed.

(h4: Reflection Optical System)

In addition, the image pick-up range of inner camera 133 can be varied by employing a reflection optical system. Thus, regardless of a position of attachment of inner camera 133 in upper housing 2, an image of a range appropriate for detection of a user's operation can be picked up.

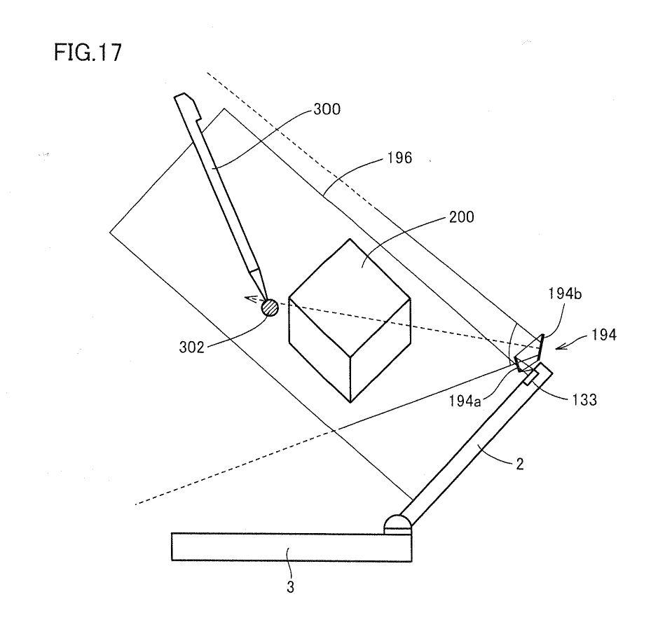

In game device 1 shown in FIG. 17, a reflection optical system 194 is attached to inner camera 133 attached to upper housing 2. This reflection optical system 194 is preferably configured to be removably attached to inner camera 133, likewise wide-angle lens 192 (FIG. 16) described above.

More specifically, reflection optical system 194 includes a primary reflection mirror 194a and a secondary reflection mirror 194b. An optical axis of inner camera 133 is incident on secondary reflection mirror 194b after it is reflected by primary reflection mirror 194a, and then directed to a range in which a user's operation is performed after it is reflected by secondary reflection mirror 194b. It is noted that the field of view (angle of view) can be expanded by implementing secondary reflection mirror 194b as a concave mirror.

By thus attaching reflection optical system 194, an entire pop-up range 196 of object 200 with respect to the display portion can be covered. Namely, when the user touches any portion of object 200 that looks like popping up, the user's operation can be sensed.

(h5: Outer Camera)

A method of sensing a user's operation with the use of inner camera 133 has been described above, however, outer cameras 131L and 131R (FIG. 3A) can also be used. Namely, game device 1 has upper housing 2 provided with upper LCD 110 representing the display portion on one surface, and outer cameras 131L and 131R representing the image pick-up portion used for calculation of a position of the marker are provided in the surface of upper housing 2 opposite to the display portion.

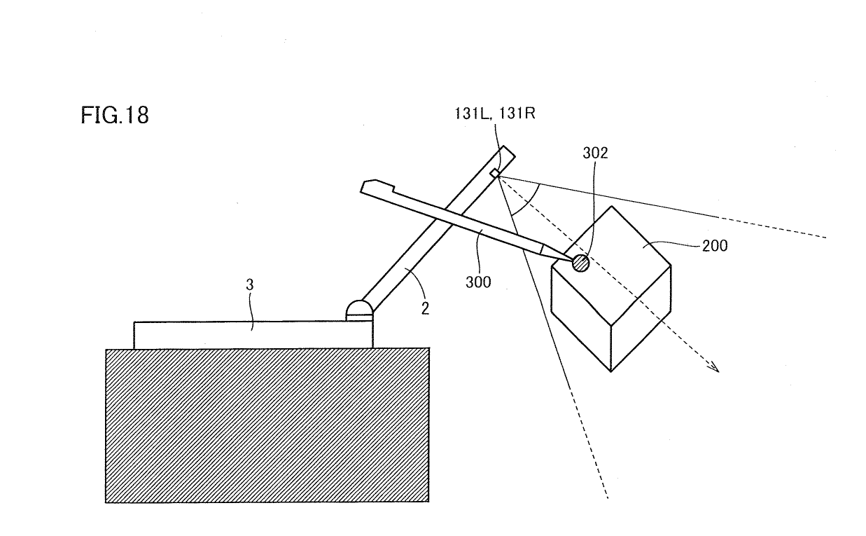

Typically, as shown in FIG. 18, while game device 1 is placed on a table (or it is held by the user), the user operates stylus 300 at a position in the rear relative to upper housing 2. By picking up an image of stylus 300 operated by the user and marker 302 attached thereto with outer cameras 131L and 131R, a position of marker 302 with respect to outer cameras 131L and 131R can be detected.

In particular, since outer cameras 131L and 131R attached to game device 1 function as stereo cameras, a position of marker 302 can also directly be calculated through stereo image pick-up without using the calculation logic as described above.

In the manner of use shown in FIG. 18, since the user's eyes cannot directly see marker 302, such an impression that an object is indirectly operated may be given. Even in such a case, by devising display on upper LCD 110, the user can enjoy an operation of an object.

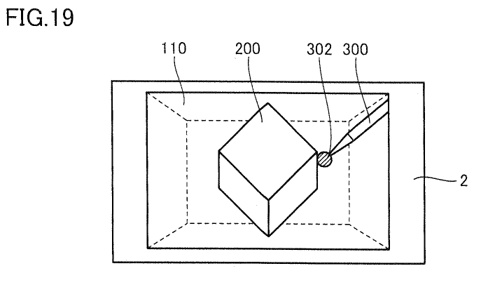

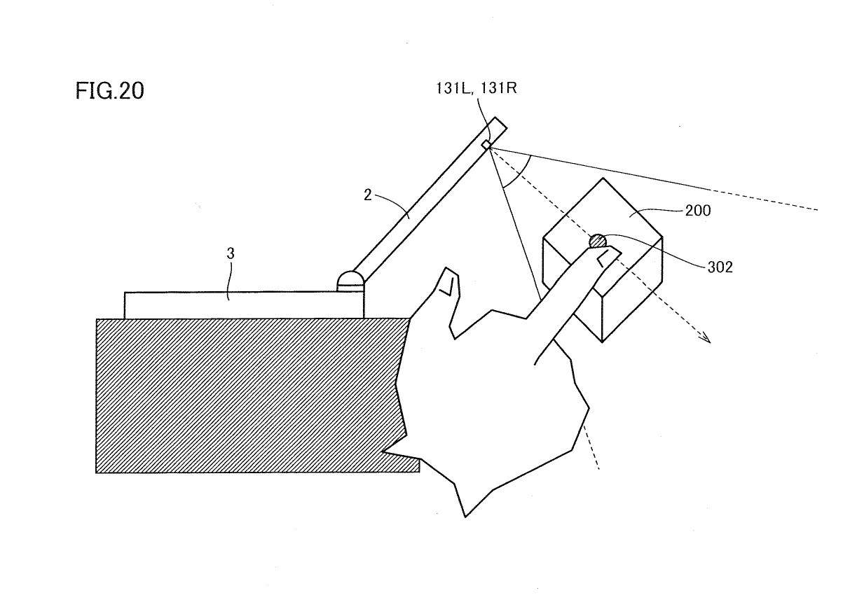

As shown in FIG. 19, stereoscopic effect with more depth relative to the display surface of upper LCD 110 can be given to the user. In addition, by displaying object 200 generated in the game processing and the image picked up by outer cameras 131L and 131R as combined, a user interface adapted to augmented reality can be provided. In this case, as shown in FIG. 20, such a form of use that marker 302 is provided at a user's fingertip and then the user performs an operation with his/her own finger is also possible.

(h6: Camera of Another Game Device)

In the description above, a method of calculating a position of marker 302 with the use of the image pick-up portion mounted on the user' own game device has been exemplified, however, a plurality of game devices 1 may be used to calculate a position of marker 302.

Specifically, it is assumed that two users face each other while each of them holds game device 1. One game device 1 uses the mounted image pick-up portion (typically, outer cameras 131L and 131R) to pick up an image of the user who operates the other game device 1 and transmits the image obtained by image pick-up to the other game device 1. The other game device 1 also similarly picks up an image of the user who operates one game device 1 and transmits the image obtained by image pick-up to one game device 1. In addition, not only outer cameras 131L and 131R are used with the users facing each other but also two inner cameras 133 may be used. The processing above may be performed with any arrangement capable of mutually making up for image pick-up ranges.

Thus, each game device 1 can sense an operation performed by a user who operates his/her own device.

Thus, an image pick-up portion for detecting a user's operation by picking up an image of the region where marker 302 for position detection representing the indicator is present does not necessarily have to be mounted on game device 1 to be operated. Namely, the game processing according to the present embodiment can also be mounted as a game system including game device 1 and an image pick-up portion separate from game device 1 as combined.

### I. Functional Block

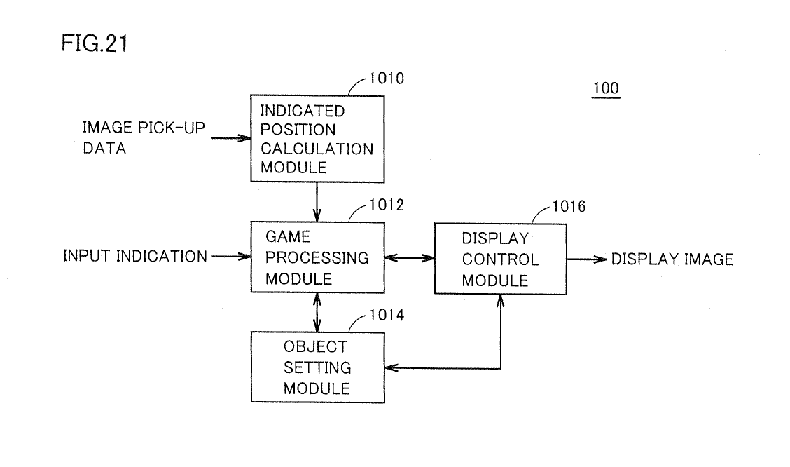

A functional block in game device 1 will be described with reference to FIG. 21. Each functional block shown in FIG. 21 is implemented as a result of reading and execution of an application program or a game program stored in game card 171 or the like by operation processing unit 100.

Referring to FIG. 21, operation processing unit 100 includes as its functions, an indicated position calculation module 1010, a game processing module 1012, an object setting module 1014, and a display control module 1016.

When indicated position calculation module 1010 accepts image pick-up data obtained by image pick-up by the image pick-up portion, it calculates a position of marker 302 in accordance with the calculation logic as described above. Namely, indicated position calculation module 1010 calculates, based on an image of marker 302 representing the indicator of which image is picked up by the image pick-up portion, a relative position of the indicator with respect to the image pick-up portion. In addition, indicated position calculation module 1010 can also calculate a position in a coordinate system of the display portion.

Object setting module 1014 sets a position of display of the object with respect to the display portion and arranges the object at a corresponding position in the virtual space. Namely, as the game or the like proceeds, object setting module 1014 sets a two-dimensional position of the object on upper LCD 110 and also a position in the direction of depth of upper LCD 110 (an amount of pop-up/an amount of recess). Moreover, object setting module 1014 arranges an object in the virtual space based on the set three-dimensional positional information.

Game processing module 1012 performs game processing based on relation between the position of display of the object set by object setting module 1014 and the relative position of marker 302 calculated by indicated position calculation module 1010. Contents in the game processing (application) provided by game processing module 1012 will be described later. Further, game processing module 1012 performs the game processing based on an input onto touch panel 122.

Display control module 1016 sets parallax based on the position of display of the object in the direction of depth of the display portion set by object setting module 1014 and causes the display portion to stereoscopically display the object. Namely, display control module 1016 obtains an image of an object to be displayed from game processing module 1012, obtains information on a position of display with respect to the display surface and an amount of parallax to be provided, and generates a pair of images to be displayed on upper LCD 110 (display image). In addition, in response to a command from game processing module 1012, display control module 1016 changes a position of display of any object or changes display contents of an object based on the user's operation.

### J. Processing Procedure

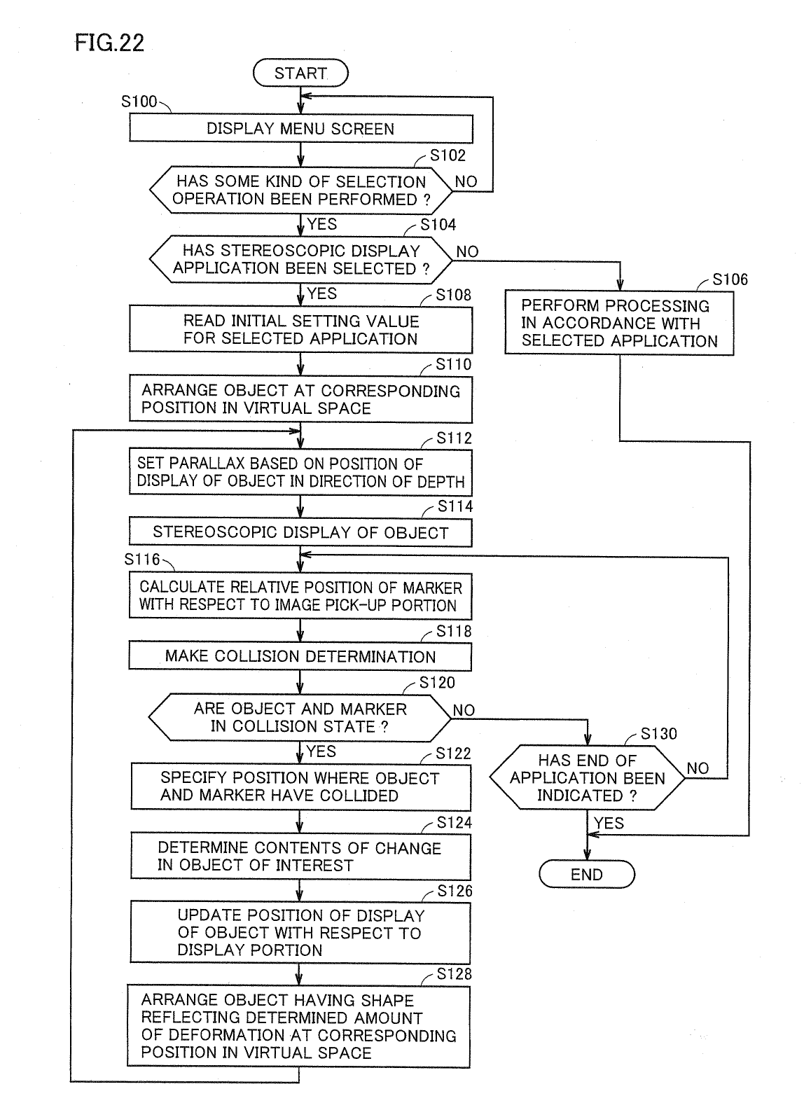

A processing procedure performed in game device 1 will be described with reference to FIG. 22. Each step in each flowchart shown in FIG. 22 is typically provided by operation processing unit 100 reading and executing an application program or a game program stored in game card 171 or the like. It is noted that operation processing unit 100 does not have to execute a single program but one application or a plurality of applications may be executed together with a program (or firmware) providing a basic OS (Operating System). In addition, the entirety or a part of processing shown below may be implemented by hardware.

Initially, operation processing unit 100 causes upper LCD 110 and/or lower LCD 120 to display a menu screen (step S100). In succession, operation processing unit 100 determines whether or not some kind of selection operation has been performed through input means for accepting an input operation from a user or the like (touch panel 122, cross-shaped button 161, button group 162 shown in FIG. 2) (step S102). When no selection operation has been performed (NO in step S102), processing in step S100 and subsequent steps is repeated.

On the other hand, when some kind of selection operation has been performed (YES in step S102), operation processing unit 100 determines whether a stereoscopic display application has been selected or not (step S104). When an application other than a stereoscopic display application has been selected (NO in step S104), operation processing unit 100 performs processing in accordance with the selected application (step S106).

On the other hand, when the stereoscopic display application has been selected) (YES in step S104), operation processing unit 100 reads an initial setting value of the selected application (step S108). Then, operation processing unit 100 sets an initial position of display of the object with respect to the display portion (step S108) and arranges the object at a corresponding position in the virtual space (step S110).

In addition, operation processing unit 100 sets parallax based on the position of display of the object in the direction of depth of upper LCD 110 (step S112). Further, operation processing unit 100 generates a pair of images in accordance with the set parallax and causes upper LCD 110 to stereoscopically display the object (step S114). Here, operation processing unit 100 has calculated the position of display of the stereoscopically displayed object (an amount of pop-up/an amount of recess).

In succession, operation processing unit 100 calculates a relative position of marker 302 with respect to the image pick-up portion based on the image of marker 302 picked up by the image pick-up portion (typically, inner camera 133) (step S116). Namely, operation processing unit 100 calculates the position of marker 302 in accordance with the equations (4) to (6) above.

In succession, operation processing unit 100 makes collision determination based on the position of display of the object and the calculated position of marker 302 (step S118). Namely, operation processing unit 100 evaluates a distance between the calculated position of display of the object and the position of marker 302 in the common X-Y-X-coordinate system and/or a trace of the calculated position of display, and the like, and determines whether the user has performed such an operation as touching the object or not. Then, operation processing unit 100 determines whether the object and marker 302 are in a collision state or not (step S120). When they are not in the collision state (NO in step S120), the process proceeds to step S130.

On the other hand, when they are in the collision state (YES in step S120), operation processing unit 100 specifies a position of collision between the object and marker 302 (step S122). In succession, operation processing unit 100 determines contents of change in object of interest in accordance with the position specified in step S122 (step S124). More specifically, operation processing unit 100 determines an amount of travel, an amount of deformation or the like of the object of interest. Then, operation processing unit 100 updates the position of display of the object with respect to the display portion in accordance with the determined amount of travel (step S126) and arranges the object in a shape reflecting the determined amount of deformation at a corresponding position in the virtual space (step S128). Then, the processing in step S112 and subsequent steps is performed.

Thus, the operation processing unit proceeds with the game in response to the detected user's operation.

In step S130, operation processing unit 100 determines whether or not end of the application has been indicated through input means for accepting an input operation from a user or the like (touch panel 122, cross-shaped button 161, button group 162 shown in FIG. 2) (step S130). When end of the application has not been indicated (NO in step S130), the processing in step S116 and subsequent steps is repeated.

On the other hand, when end of the application has been indicated (YES in step S130), operation processing unit 100 ends the application (game processing).

### K. Force Feedback Function

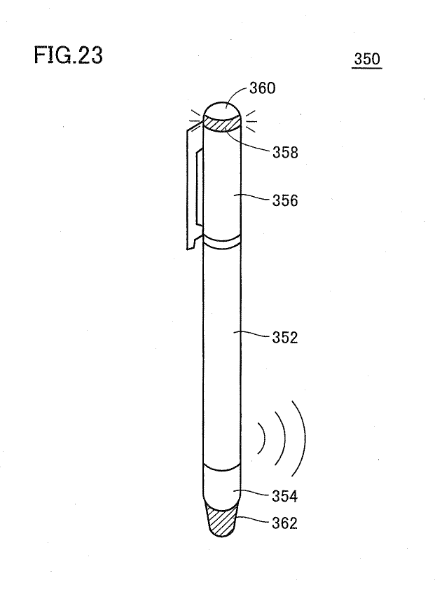

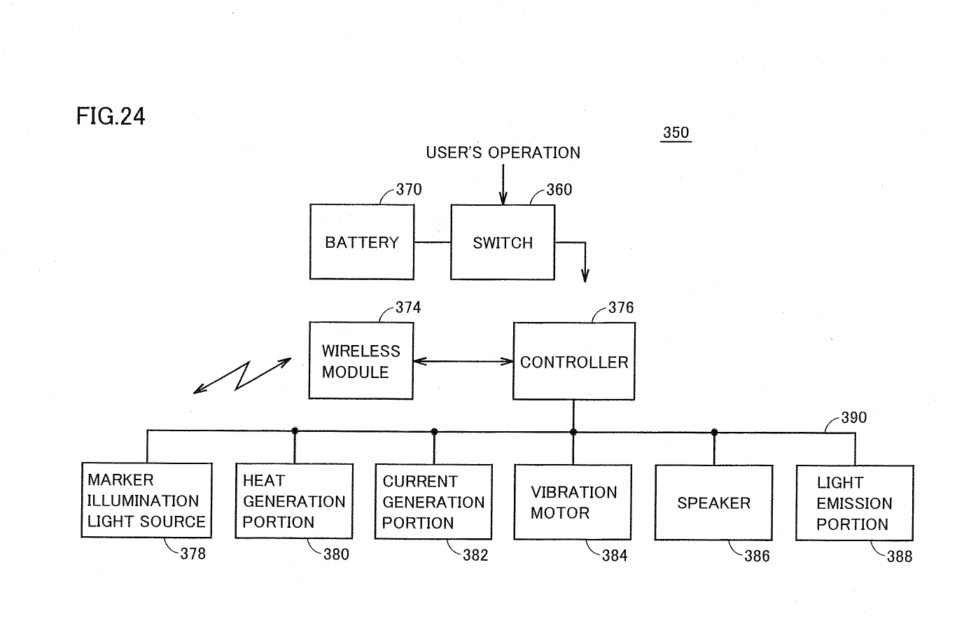

Prior to description of an application provided by game device 1, a stylus 350 with a force feedback function will be described with reference to FIGS. 23 and 24.

The force feedback function herein refers to giving the user, when the user performs some kind of operation, feedback to that operation that can be felt with the five senses. Examples of feedback given to the user as such include vibration, voice and sound, light, generation of current, variation in temperature, and the like. Though an example in which stylus 350 shown in FIGS. 23 and 24 is configured to be able to give a plurality of types of feedback is shown, only a specific type of feedback among them can be given. For example, such a configuration that only vibration is given to the user as the game proceeds can also be adopted.

Referring to FIG. 23, stylus 350 has a shape like a pen, and it is constituted of a first force generation portion 354, a second force generation portion 356, an illumination portion 358, a switch 360, and a marker 362, with a main shaft portion 352 being the center.

As will be described later, various circuits and the like are mounted on main shaft portion 352.

First force generation portion 354 is a portion against which the user presses his/her forefinger and thumb when he/she holds stylus 350. Then, first force generation portion 354 can give the user (1) electric shock caused by a weak current and/or (2) temperature increase caused by internal heating, and the like. For example, such a manner of use that, when the user fails in some kind of application, first force generation portion 354 is caused to generate a weak current to apply electric shock to the user or to generate heat to have the user feel variation in temperature, is assumed.

Second force generation portion 356 is a portion in contact with a root of the user's thumb when he/she holds stylus 350. Then, second force generation portion 356 can give the user (1) vibration and/or (2) voice and sound such as sound effect. For example, such a manner of use that, when the user fails in some kind of application, second force generation portion 356 gives the user vibration or outputs voice and sound to the user, is assumed.

Illumination portion 358 is a portion that can be viewed from the user even when he/she holds stylus 350. Then, illumination portion 358 illuminates or flashes in accordance with an instruction from game device 1 or the like, and gives the user light as feedback as the game proceeds.

Switch 360 is provided in an upper portion of stylus 350 and its power is turned ON/OFF in response to pressing by the user.

Marker 362 has such a color as not being present in a real world applied (typically, a fluorescent color) to its surface, as in marker 302 of stylus 300 shown in FIG. 1. Since a power supply is mounted on stylus 350, however, light in an infrared region may be emitted from an infrared LED, in order to enhance accuracy in detecting a position of marker 362.

A specific internal configuration of stylus 350 will now be described with reference to FIG. 24. Referring to FIG. 24, stylus 350 includes a battery 370, a switch 360, a wireless module 374, a controller 376, a marker illumination light source 378, a heat generation portion 380, a current generation portion 382, a vibration motor 384, a speaker 386, and a light emission portion 388.

A battery having a relatively small size such as a button battery is typically adopted as battery 370. Battery 370 is preferably a rechargeable secondary battery. Electric power supplied from battery 370 is supplied to each portion through a not-shown cable through switch 360.

As shown in FIG. 23, switch 360 is provided in the upper portion of stylus 350 and turns ON/OFF electric power supply from battery 370 to each portion in response to the user's operation (pressing).

Wireless module 374 is configured to be able to communicate with wireless module 134 (FIG. 5) of game device 1 and it mainly passes a wireless signal transmitted from game device 1 to controller 376. More specifically, when some kind of user's operation is performed, game device 1 senses operation contents thereof and performs game processing in accordance with the contents of the sensed user's operation. Then, when game device 1 determines that some kind of force feedback should be given to the user as a part of results of the game processing performed, it transmits a corresponding instruction to stylus 350 through a wireless signal. Then, in response to the instruction, controller 376 provides a corresponding command to a connected actuator. It is noted that wireless module 374 may modulate information from controller 376 into a wireless signal and then transmit the wireless signal to game device 1. For example, a configuration supporting wireless communication in accordance with a dedicated protocol such as Bluetooth®, infrared communication, wireless LAN (802.11 specifications), and the like can be adopted for this wireless module 374.

Marker illumination light source 378 is arranged in marker 362 of stylus 350 and it illuminates in response to a command from controller 376. An infrared LED or the like is typically employed as this marker illumination light source 378.

Heat generation portion 380 is thermally connected to a surface of first force generation portion 354 and generates heat in response to a command from controller 376. A resistor or the like is typically employed as heat generation portion 380.

Current generation portion 382 is electrically connected to the surface of first force generation portion 354 and generates a weak current in response to a command from controller 376.

Vibration motor 384 is contained in second force generation portion 356 of stylus 350 and generates vibration as it rotates in response to a command from controller 376. An eccentric motor typically implements this vibration motor 384.

Speaker 386 is contained in second force generation portion 356 or the like of stylus 350 and it generates sound effect or the like in response to a command from controller 376.

Light emission portion 388 is contained in illumination portion 358 of stylus 350 and it illuminates or flashes in response to a command from controller 376.

By thus using stylus 350 with such a force feedback function in game device 1, such feeling as directly touching an object in the virtual space can be obtained not only from the sense of sight but also from the sense of touch, the sense of hearing and the like.

### L. Application

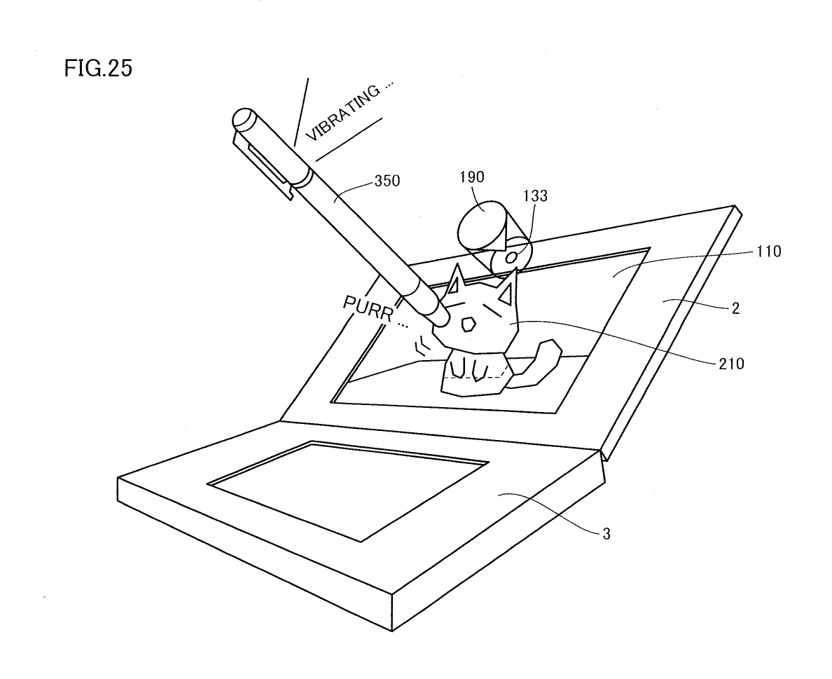

An example of an application provided by game device 1 will now be described with reference to FIGS. 25 to 30. An application described below is basically executed in accordance with the flowchart shown in FIG. 22 above.

(l1: Physical Affection Game)

As shown in FIG. 25, game device 1 displays an object 210 representing a pet as popping up from the display surface. When the user performs such an operation as patting stereoscopically displayed object 210 with stylus 350 or the like at a visually recognized position, object 210 representing the pet gives an expression responding to patting.

Description is given in accordance with the flowchart shown in FIG. 22 above. When it is determined in the collision determination processing that a position of display of a character object and the calculated marker position have collided against each other, a position of display and contents of display of object 210 are updated as appropriate such that the object gives an expression in conformity with a portion of object 210 (for example, cheek, head or the like) corresponding to the marker position.

In a case where stylus 350 equipped with the force feedback function as described above is used, when it is determined in the collision determination processing described above that the stylus has touched object 210, vibration may be generated in stylus 350 in response thereto. In this case, a wireless signal indicating generation of vibration is provided from game device 1 to stylus 350. Namely, game device 1 (game processing module 1012 in FIG. 21) performs the game processing based on the calculated stylus position and causes vibration to be generated from stylus 350 (vibration motor 384) as the game processing proceeds.

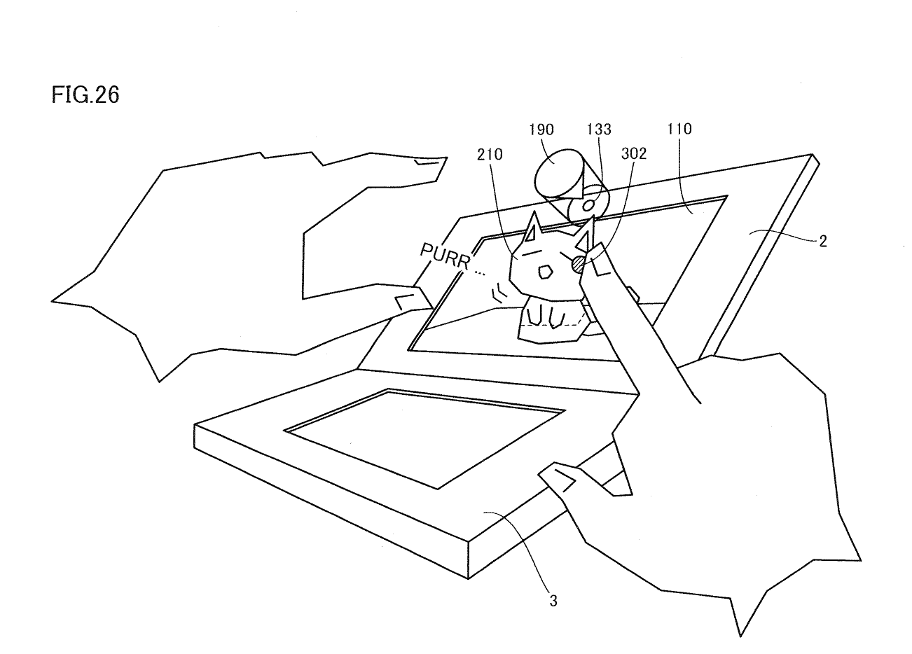

In addition, as shown in FIG. 26, in this physical affection game, such a form as the user's operation with his/her finger instead of stylus 350 is more likely to lead to feeling of direct touch. In this case, by attaching marker 302 for position detection to a fingertip with which the user performs an operation, processing similar to that in the case of stylus 350 can be performed.

In a case where an operation is performed with the user's own finger as such, a position of the fingertip can also be calculated by using a skin color sensing technique or the like. Namely, a skin color region in an image obtained by image pick-up by the image pick-up portion (typically, inner camera 133) is extracted and a position of the fingertip is specified based on a shape or the like thereof. Then, the specified coordinate of the fingertip is calculated as the position of the indicator.

In addition, in a case where such a skin color sensing technique is used, positions of a plurality of fingers can be detected and hence such a user's operation as touching object 210 with a plurality of fingers (right hand and left hand) can also be performed.

(l2: Soap Bubble Carrying Game)

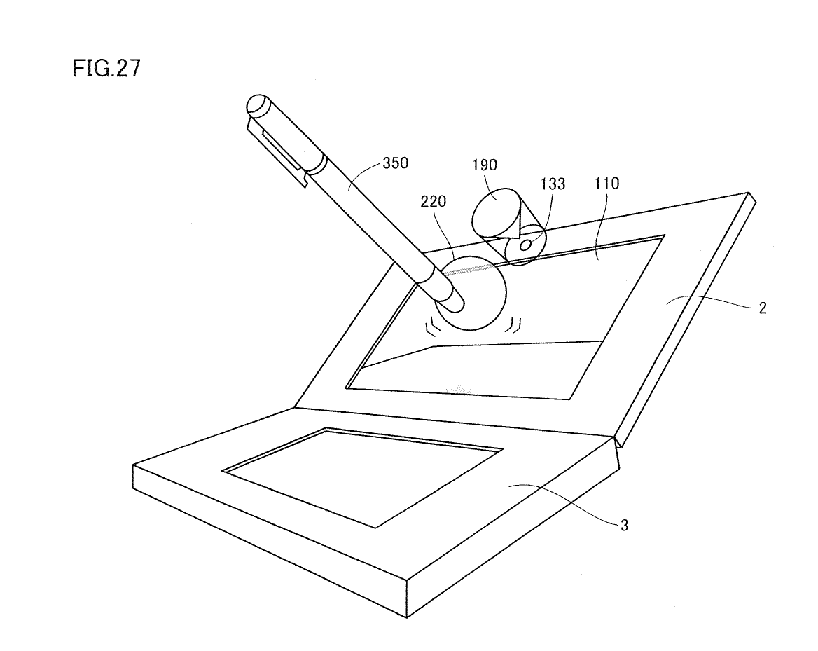

As shown in FIG. 27, game device 1 displays an object 220 representing a soap bubble as popping up from the display surface. The user touches stereoscopically displayed soap bubble object 220 with stylus 350 or the like to carry the object to a designated target value. An operation of an object of which feel of touch has not been experienced even in a real world, such as a soap bubble or smoke shown in FIG. 27, is suitable for an operation with stylus 350.

In addition, by adding such determination processing that a soap bubble bursts if the user forcibly touches the soap bubble, zest of the game can be enhanced. More specifically, change over time of a position of calculated marker 362 is obtained, and when this change over time exceeds a prescribed threshold value, determination as forcible touch can be made.

(l3: Sketch Game)

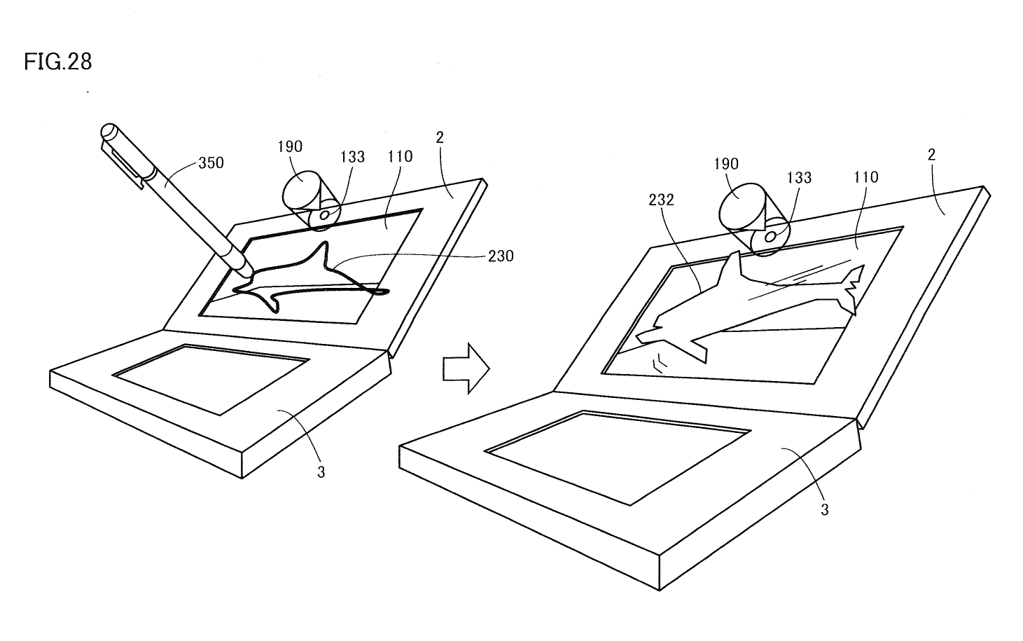

As shown in FIG. 28, game device 1 displays an object 230 showing a trace of the user's operation of stylus 350 as popping up from the display surface. Then, such an effect that an object 232 drawn in a space starts to move as soon as this object 230 is closed by the user's operation is provided. FIG. 28 shows an example of such an effect that, as the user draws a dolphin in a space, the dolphin starts to move.

(l4: Iron Ball Carrying Game)

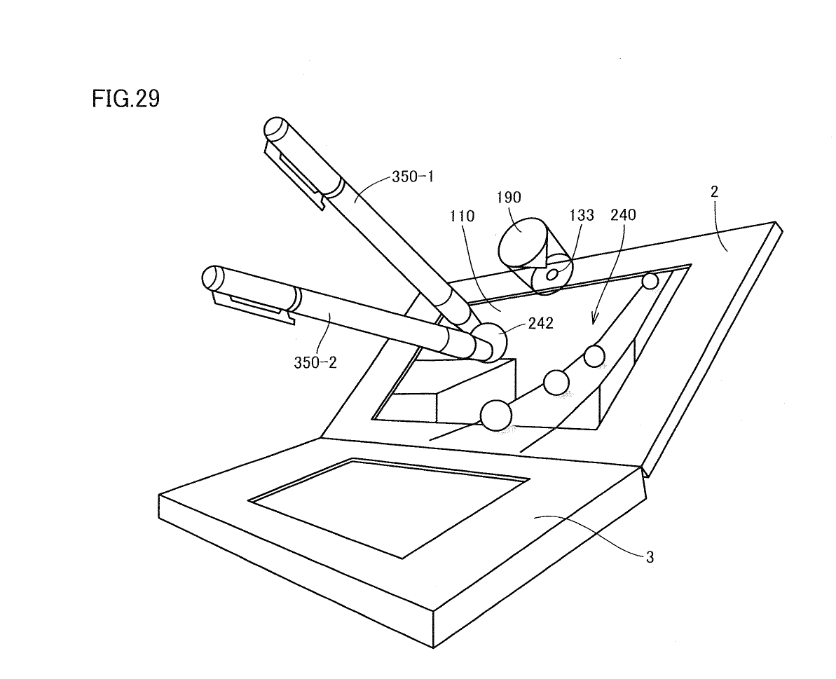

As shown in FIG. 29, game device 1 provides such a game that an iron ball object 242 stereoscopically displayed as if it popped up along a rail object 240 from the rear of the display surface is picked and carried with the use of two styluses 350-1 and 350-2. Namely, the user can enjoy the game by using two styluses like “chopsticks”.

In such a game, a position of display of iron ball object 242 stereoscopically displayed as popping up may be changed toward the rear in two-dimensional display, in coordination with an operation of stereoscopic vision volume 145 (FIG. 2).

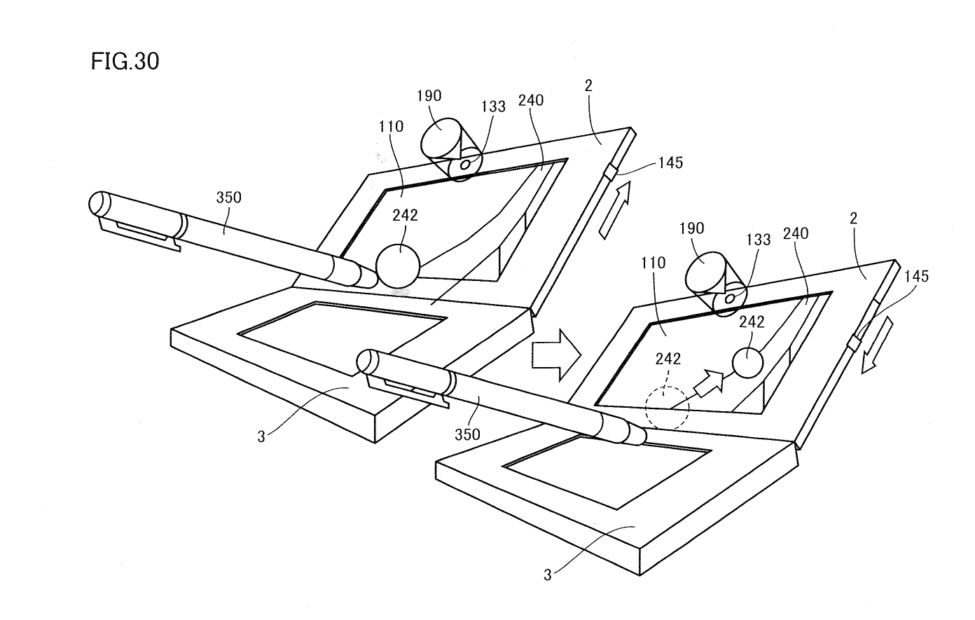

Namely, as shown in FIG. 30, as the user operates stereoscopic vision volume 145 toward two-dimensional display, an amount of parallax provided to the image displayed on upper LCD 110 is set to substantially zero. Therefore, the user cannot stereoscopically see the object. Accordingly, a position of display of iron ball object 242 that has been displayed along rail object 240 (a relative position with respect to rail object 240) is changed to a position that can visually be recognized further toward the rear.

By thus changing stereoscopic vision volume 145 that has been set to stereoscopic display to two-dimensional display, the user can no longer touch the object that has stereoscopically been displayed and could be touched by the user until just before. In order to be able to feel this sense also visually, when stereoscopic vision volume 145 is changed to two-dimensional display, a position of display of iron ball object 242 itself is also displayed to move toward the rear along rail object 240. Thus, the user can intuitively feel also visually that he/she cannot touch iron ball object 242 because it is located in the rear of the screen.

(l5: Others)

Other than the applications described above, the following applications are assumed.

(1) Working Game

A game of sculpturing a statue as the user performs a sculpturing operation on a stereoscopically displayed wood object. Alternatively, a game of creating a desired craftwork by a user's embossing operation or spray-painting operation on a stereoscopically displayed metal.

(2) Cooking Game

A game in which the user can realistically perform such an operation as cutting ingredients, mixing, using a knife, and handling a pan, in a process of cooking desired dishes.

(3) Balloon Game

A game in which the user performs such an operation as flicking a stereoscopically displayed balloon object and guiding the balloon to the goal while avoiding obstacles different in height.

(4) Beauty Parlor Game

A game in which, from a stereoscopic point of view, a hair style of a stereoscopically displayed head object is set by cutting, shampooing, and blowing.

### M. Variation

For example, one exemplary embodiment can also be implemented as a non-transitory computer readable recording medium contained in a game device as described above or as a game program (instruction set) stored in a non-transitory computer readable recording medium that can removably be attached to an information processing apparatus.

In the former case, the game program is read by a game device having a display portion capable of providing stereoscopic display and the processing is performed in the computer. Namely, the game program is executed by the game device having the display portion capable of providing stereoscopic display so that a game image is stereoscopically displayed by utilizing parallax.

In the latter case, a system including a game device main body having a display portion capable of providing stereoscopic display and a recording medium providing a game program to the game device main body is configured.

In any case, the game program stored in a computer readable recording medium does not have to include all game programs necessary for processing provided by the game device described above. Namely, an instruction set or a library essentially possessed by a processing apparatus main body such as the game device may be made use of so as to realize functions provided by the game device according to the present embodiment as described above.

In addition, in the embodiment described above, though a case where a series of processes is performed in a single game device has been described, the series of processes above may be implemented as being distributed among a plurality of processing entities. For example, in a system including the game device and a server device capable of communicating with the game device through a network, a part of the series of processes above may be performed by the server device.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. A game device for providing stereoscopic display of a game image by utilizing parallax, comprising:
a display portion capable of providing said stereoscopic display;
an image pick-up portion;
an object setting unit for setting a position of display of an object with respect to said display portion and arranging the object at a corresponding position in a virtual space;
a display control unit for setting parallax based on the position of display of said object in a direction of depth of said display portion for causing said display portion to stereoscopically display said object;
an indicated position calculation unit for calculating a relative position of an indicator with respect to said image pick-up portion based on an image of the indicator of which image is picked up by said image pick-up portion; and
a game processing unit for performing game processing based on relation between the position of display of said object and calculated said relative position.

2. The game device according to claim 1, further comprising a first housing provided with said display portion on one surface, wherein
said image pick-up portion is provided in a surface of said first housing common to a surface where said display portion is provided.

3. The game device according to claim 1, further comprising a first housing provided with said display portion on one surface, wherein
said image pick-up portion is provided in a surface of said first housing opposite to said display portion.

4. The game device according to claim 3, wherein
said display control unit causes said display portion to display an image picked up by said image pick-up portion together with an image of said object.

5. The game device according to claim 1, wherein
said indicator is a stylus having a marker at a tip end, and
said indicated position calculation unit calculates a position of said stylus in the direction of depth of said display portion based on a size of an image representing said marker within an image picked up by said image pick-up portion.

6. The game device according to claim 5, wherein
said stylus includes a vibration generation portion for generating vibration, and
said game processing unit performs game processing based on calculated said position of the stylus and causes said vibration generation portion to generate vibration as the game processing proceeds.

7. The game device according to claim 2, further comprising:
a second housing coupled to said first housing to be foldable; and
a touch panel provided in said second housing, wherein
said game processing unit further performs game processing based on an input on said touch panel.

8. The game device according to claim 2, further comprising a lens removably provided in said image pick-up portion, for guiding an image all around said image pick-up portion to said image pick-up portion.

9. The game device according to claim 2, further comprising a wide-angle lens removably provided in said image pick-up portion.

10. The game device according to claim 2, further comprising a reflection optical system removably provided in said image pick-up portion, for variably setting a range of image pick-up by said image pick-up portion.

11. A method of providing a game including stereoscopic display of a game image by utilizing parallax, in a game device having a display portion capable of providing stereoscopic display, comprising:
an object setting step of setting a position of display of an object with respect to said display portion and arranging the object at a corresponding position in a virtual space;
a display control step of setting parallax based on the position of display of said object in a direction of depth of said display portion for causing said display portion to stereoscopically display said object;
an indicated position calculation step of calculating a relative position of an indicator with respect to an image pick-up portion based on an image of the indicator of which image is picked up by said image pick-up portion; and
a game processing step of performing game processing based on relation between the position of display of said object and calculated said relative position.

12. The method of providing a game according to claim 11, wherein
said display control step includes the step of displaying an image picked up by said image pick-up portion with respect to said display portion together with an image of said object.

13. The method of providing a game according to claim 11, wherein
said indicator is a stylus having a marker at a tip end, and
said indicated position calculation step includes the step of calculating a position of said stylus in the direction of depth of said display portion based on a size of an image representing said marker within an image picked up by said image pick-up portion.

14. A non-transitory storage medium encoded with a computer readable game program and executable by a computer of a game device including a display portion capable of providing stereoscopic display, the computer readable game program comprising:
object setting instructions for setting a position of display of an object with respect to said display portion and arranging the object at a corresponding position in a virtual space;
display control instructions for setting parallax based on the position of display of said object in a direction of depth of said display portion for causing said display portion to stereoscopically display said object;
indicated position calculation instructions for calculating a relative position of an indicator with respect to an image pick-up portion based on an image of the indicator of which image is picked up by said image pick-up portion; and
game processing instructions for performing game processing based on relation between the position of display of said object and calculated said relative position.

15. A game system, comprising:
an image pick-up portion; and
a game device for stereoscopically displaying a game image by utilizing parallax,
said game device including
a display portion capable of providing stereoscopic display,
an object setting unit for setting a position of display of an object with respect to said display portion and arranging the object at a corresponding position in a virtual space,
a display control unit for setting parallax based on the position of display of said object in a direction of depth of said display portion for causing said display portion to stereoscopically display said object,
an indicated position calculation unit for calculating a relative position of an indicator with respect to said image pick-up portion based on an image of the indicator of which image is picked up by said image pick-up portion, and
a game processing unit for performing game processing based on relation between the position of display of said object and calculated said relative position.
